(19) United States
(12) Patent Application Publication
(10) Pub. No.: US 2025/0086824 A1
(43) Pub. Date: Mar. 13, 2025

(54) WEARABLE SYSTEM WITH HEADSET AND CONTROLLER INSIDE-OUT TRACKING

(71) Applicant: Magic Leap, Inc., Plantation, FL (US)

(72) Inventors: Dominik Michael Kasper, Zurich (CH); Martin Georg Zahnert, Zurich (CH); Manel Quim Sanchez Nicuesa, Zurich (CH); Rafa Gomez-Jordana Manas, Kilchberg (CH); Nathan Yuki Baumli, Dattwil (CH); Koon Keong Shee, Miramar, FL (US); Zachary C. Nienstedt, Fort Lauderdale, FL (US); Emily Elizabeth Mount, Sunnyvale, CA (US); Lomesh Agarwal, Fremont, CA (US); Andrea Lampart, Fremont, CA (US)

(73) Assignee: Magic Leap, Inc., Plantation, FL (US)

(21) Appl. No.: 18/956,664

(22) Filed: Nov. 22, 2024

Related U.S. Application Data
(63) Continuation of application No. PCT/US2023/023271, filed on May 23, 2023.
(60) Provisional application No. 63/345,159, filed on May 24, 2022.
(60) Provisional application No. 63/345,162, filed on May 24, 2022.

(51) Int. Cl. G06T 7/70; G02B 27/00; G02B 27/01; G06F 3/01

(52) U.S. Cl. CPC G06T 7/70; G02B 27/017; G02B 27/0093; G02B 2027/0138; G06F 3/012; G06T 2207/30204

(57) ABSTRACT

Wearable systems and method for operation thereof incorporating headset and controller inside-out tracking are disclosed. A wearable system may include a headset and a controller. The wearable system may cause fiducials of the controller to flash. The wearable system may track a pose of the controller by capturing headset images using a headset camera, identifying the fiducials in the headset images, and tracking the pose of the controller based on the identified fiducials in the headset images and based on a pose of the headset. While tracking the pose of the controller, the wearable system may capture controller images using a controller camera. The wearable system may identify two-dimensional feature points in each controller image and determine three-dimensional map points based on the two-dimensional feature points and the pose of the controller.

### CROSS-REFERENCES TO RELATED APPLICATIONS

This application is a continuation of International Patent Application No. PCT/US2023/023271, filed May 23, 2023, entitled “WEARABLE SYSTEM WITH HEAD SENT AND CONTROLLER INSIDE-OUT TRACKING,” which claims the benefit of and priority to U.S. Provisional Patent Application No. 63/345,159, filed May 24, 2022, entitled “WEARABLE SYSTEM WITH CONTROLLER LOCALIZATION USING HEADSET CAMERAS AND CONTROLLER FIDUCIALS,” and U.S. Provisional Patent Application No. 63/345,162, filed May 24, 2022, entitled “WEARABLE SYSTEM WITH HEADSET AND CONTROLLER INSIDE-OUT TRACKING,” the entire disclosures of which are incorporated herein by reference for all purposes.

### BACKGROUND OF THE INVENTION

Modern computing and display technologies have facilitated the development of systems for so called “virtual reality” or “augmented reality” experiences, wherein digitally reproduced images or portions thereof are presented to a user in a manner wherein they seem to be, or may be perceived as, real. A virtual reality, or “VR,” scenario typically involves presentation of digital or virtual image information without transparency to other actual real-world visual input; an augmented reality, or “AR,” scenario typically involves presentation of digital or virtual image information as an augmentation to visualization of the actual world around the user.

Despite the progress made in these display technologies, there is a need in the art for improved methods, systems, and devices related to augmented reality systems.

### BRIEF SUMMARY OF THE INVENTION

The present disclosure relates generally to techniques for improving the performance and user experience of optical systems. More particularly, embodiments of the present disclosure provide methods for operating an augmented reality (AR), virtual reality (VR), or mixed reality (MR) wearable system in which a handheld device is employed for assisting operation of the wearable system. Although portions of the present disclosure are described in reference to an AR system, the disclosure is applicable to a variety of applications.

A summary of the various embodiments of the invention is provided below as a list of examples. As used below, any reference to a series of examples is to be understood as a reference to each of those examples disjunctively (e.g., “Examples 1-4” is to be understood as “Examples 1, 2, 3, or 4”).

Example 1 is a method of operating a wearable system comprising a headset and a controller, the method comprising: causing a set of fiducials of the controller to flash, the set of fiducials being arranged in a known geometry; tracking a pose of the controller by: capturing a set of headset images using a headset camera of the headset; identifying the set of fiducials in the set of headset images; tracking the pose of the controller based on the identified set of fiducials in the set of headset images and based on a pose of the headset; while tracking the pose of the controller, capturing a set of controller images using a controller camera of the controller; identifying a set of two-dimensional feature points in each controller image of the set of controller images; and determining a set of three-dimensional map points based on the set of two-dimensional feature points and the pose of the controller.

Example 2 is the method of example(s) 1, wherein the wearable system comprises: the headset comprising: the headset camera; and a headset inertial measurement unit; and the controller comprising: the set of fiducials arranged in the known geometry; the controller camera; and a controller inertial measurement unit; wherein the wearable system is configured to determine a position or orientation of the headset or the controller based on data captured by the headset camera, the controller camera, the headset inertial measurement unit, or the controller inertial measurement unit.

Example 3 is the method of example(s) 1, further comprising: generating a map using the set of three-dimensional map points, wherein each three-dimensional map point of the set of three-dimensional map points corresponds to a particular feature in an environment of the wearable system.

Example 4 is the method of example(s) 3, wherein the map comprises a map point identifier and a feature identifier associated with each three-dimensional map point of the set of three-dimensional map points.

Example 5 is the method of example(s) 3, wherein the map comprises a list of keyframe poses and a corresponding list of the set of two-dimensional feature points for each three-dimensional map point of the set of three-dimensional map points.

Example 6 is the method of example(s) 1, further comprising: generating a set of transforms representing a position and an orientation of the controller relative to the headset at a set of time instances corresponding to when each of the set of controller images were captured; and associating the set of transforms with the set of controller images.

Example 7 is the method of example(s) 6, further comprising: determining a location of a three-dimensional map point of the set of three-dimensional map points by triangulating a two-dimensional feature point of the set of two-dimensional feature points in each of the set of controller images using the set of transforms.

Example 8 is a method of operating a wearable system comprising a headset and a controller, the method comprising: determining a set of three-dimensional map points based on data captured by one or more sensors of the headset; sending the set of three-dimensional map points from the headset to the controller; capturing one or more controller images using a controller camera of the controller; identifying a set of two-dimensional feature points in each of the one or more controller images; and determining a pose of the controller based on the set of two-dimensional feature points in each of the one or more controller images and the set of three-dimensional map points.

Example 9 is the method of example(s) 8, wherein determining the pose of the controller comprises: determining one or more of the set of two-dimensional feature points that correspond to one or more of the set of three-dimensional map points.

Example 10 is the method of example(s) 8, further comprising: generating a map including the set of three-dimensional map points, wherein each three-dimensional map point of the set of three-dimensional map points corresponds to a particular feature in an environment of the wearable system.

Example 11 is the method of example(s) 10, wherein each map point map comprises a map point identifier and a feature identifier associated with each three-dimensional map point of the set of three-dimensional map points.

Example 12 is the method of example(s) 8, wherein the controller is configured to extract the set of two-dimensional feature points in the one or more controller images and send the set of two-dimensional feature points to the headset, and wherein the headset is configured to: determine the pose of the controller based on the set of two-dimensional feature points in each of the one or more controller images and the set of three-dimensional map points; initialize a map of the set of three-dimensional map points based on the pose of the controller; and send the map to the controller.

Example 13 is a method of operating a wearable system comprising a headset and a controller, the method comprising: determining a set of three-dimensional map points based on data captured by one or more sensors of the controller; sending the set of three-dimensional map points from the controller to the headset; capturing a set of headset images using a headset camera of the headset; identifying a set of two-dimensional feature points in each of the set of headset images; and determining a pose of the headset based on the set of two-dimensional feature points in each of the set of headset images and the set of three-dimensional map points.

Example 14 is the method of example(s) 13, wherein determining the pose of the controller comprises: determining one or more of the set of two-dimensional feature points that correspond to one or more of the set of three-dimensional map points.

Example 15 is the method of example(s) 13, further comprising: generating a map including the set of three-dimensional map points, wherein each three-dimensional map point of the set of three-dimensional map points corresponds to a particular feature in an environment of the wearable system.

Example 16 is the method of example(s) 15, wherein each map point map comprises a map point identifier and a feature identifier associated with each three-dimensional map point of the set of three-dimensional map points.

Example 17 is the method of example(s) 13, wherein the controller comprises: a first controller camera positioned on a first side of the controller and having a first field of view; and a second controller camera positioned on a second side of the controller that is opposite the first side and having a second field of view, wherein the first field of view and the second field of view are non-overlapping.

Example 18 is a method of operating a wearable system comprising a headset and a controller, the method comprising: tracking a pose of a controller with respect to a headset; capturing a controller image of an object using a controller camera of the controller, wherein the object is within a field of view (FOV) of the controller camera but not in a FOV of a headset camera of the headset; analyzing the object to: determine a position and/or an orientation of the object; and generate virtual content for display at the headset such that the virtual content is perceived as being positioned at the position.

Example 19 is the method of example(s) 18, wherein the position and/or the orientation is relative to the pose of the controller.

Example 20 is the method of example(s) 18, wherein the virtual content corresponds to a three-dimensional reconstruction of the object.

Example 21 is the method of example(s) 18, wherein the object comprises a printed code that identifies the object, and wherein the method further comprises: identifying the printed code in the controller image; and decoding the printed code to determine the virtual content associated with the object and a position and an orientation of the object relative to a position and orientation of the printed code.

Example 22 is the method of example(s) 21, wherein the printed code comprises a barcode or a quick response (QR) code.

Example 23 is the method of example(s) 18, wherein the wearable system comprises: the headset comprising: the headset camera; and a headset inertial measurement unit; and the controller comprising: a set of fiducials arranged in a known geometry; one or more controller cameras including the controller camera; and a controller inertial measurement unit; wherein the wearable system is configured to determine another position or another orientation of the headset or the controller based on data captured by the headset camera, the one or more controller cameras, the headset inertial measurement unit, or the controller inertial measurement unit.

Example 24 is a method of operating a wearable system comprising a headset and a controller, the method comprising: determining a first set of three-dimensional map points based on data captured by one or more sensors of the headset; determining a second set of three-dimensional map points based on data captured by one or more sensors of the controller; and performing one or both of: sending the first set of three-dimensional map points from the headset to the controller and merging one or more of the first set of three-dimensional map points with the second set of three-dimensional map points; or sending the second set of three-dimensional map points from the controller to the headset and merging one or more of the second set of three-dimensional map points with the first set of three-dimensional map points.

Example 25 is the method of example(s) 24, wherein merging one or more of the first set of three-dimensional map points with the second set of three-dimensional map points and merging one or more of the second set of three-dimensional map points with the first set of three-dimensional map points comprises adding map points.

Example 26 is the method of example(s) 24, wherein merging one or more of the first set of three-dimensional map points with the second set of three-dimensional map points and merging one or more of the second set of three-dimensional map points with the first set of three-dimensional map points comprises combining or averaging map points.

Example 27 is the method of example(s) 24, further comprising: determining a first map point in the first set of three-dimensional map points is excluded from the second set of three-dimensional map points; and adding the first map point to the second set of three-dimensional map points.

Example 28 is the method of example(s) 24, wherein the determining a first position of a first map point in the first set of three-dimensional map points is different from a second position of a second map point in the second set of three-dimensional map points, wherein the first map point and the second map point correspond to a same feature; and generating a third map point by averaging the first position and the second position, wherein the third map point represents the first map point and the second map point.

Example 29 is the method of example(s) 24, wherein the second set of three-dimensional map points includes a map point of a feature that is not within a field of view of a headset camera of the headset, and wherein the method further comprises: generating virtual content corresponding to the map point for display at the headset in response to sending the second set of three-dimensional map points from the controller to the headset and merging one or more of the second set of three-dimensional map points with the first set of three-dimensional map points.

Example 30 is a wearable system configured to perform the method of any of example(s) 1-29.

Example 31 is a non-transitory computer-readable medium comprising instructions that, when executed by one or more processors, cause the one or more processors to perform operations of the method of any of example(s) 1-29.

### BRIEF DESCRIPTION OF THE DRAWINGS

FIG. 1 illustrates an augmented reality scene as viewed through a wearable augmented reality device;

FIGS. 2A-2B illustrate augmented reality devices having fixed focal planes;

FIG. 3 illustrates a schematic view of an example wearable system;

FIG. 4 illustrates an example of how a visual tracking system may be incorporated into an augmented system having a wearable device and a handheld device;

FIG. 5 illustrates a diagram of a localization task, as performed by an augmented reality system;

FIG. 6 illustrates a diagram of feature mapping from images of an environment;

FIG. 7 illustrates an exemplary flowchart and corresponding diagrams of using constellation tracking to generate map points of an environment;

FIG. 8 illustrates an example method of using constellation tracking to determine map points, according to some embodiments of the present invention;

FIG. 9 illustrates a diagram showing example steps for determining a pose of a controller without a headset performing constellation tracking;

FIGS. 10A-10D illustrate a process of using map points to determine a pose of a controller of a wearable system;

FIG. 11 illustrates an example method of using map points to determine a pose of a controller of a wearable system, according to some embodiments of the present invention;

FIGS. 12A-12D illustrate a process of using map points to determine a pose of a headset of a wearable system;

FIG. 13 illustrates a process of a headset localizing a controller from image features and map points;

FIGS. 14A-14E illustrate aspects of controller cameras for reducing motion blur in images;

FIG. 15 illustrates an example method of using map points to determine a pose of a headset of a wearable system, according to some embodiments of the present invention;

FIG. 16 illustrates an example of localizing an item with respect to a controller;

FIG. 17 illustrates an example method of positioning and virtual reconstruction from scanned objects, according to some embodiments of the present invention;

FIGS. 18A-18B illustrate examples of merging map points at a headset or a controller;

FIG. 19 illustrates an example method of merging map points at a headset or a controller, according to some embodiments of the present invention; and

FIG. 20 illustrates a simplified computer system.

### DETAILED DESCRIPTION OF THE INVENTION

Some aspects of the present disclose relate to localization (e.g., position, orientation, and/or distance) of a handheld device, such as a controller, with respect to a wearable device, such as an augmented reality (AR), virtual reality (VR), or mixed reality (MR) headset. In some instances, six degrees of freedom (6DOF) pose tracking of the headset may be performed using one or more headset sensors, such as one or more headset inertial measurement units (IMUs) and one or more headset cameras in a technique referred to as “headset inside-out tracking”. For each image captured by the headset cameras, features may be identified in the image and the pixel positions of the identified features may be compared to pixel positions of the same features in other images, allowing for the 6DOF pose of the headset to be calculated for each image.

Concurrently, 6DOF pose tracking of the controller may be performed using a combination of headset sensors and controller sensors or components, and using one or both of two separate techniques. The first technique is referred to as “controller inside-out tracking”, which is 6DOF pose tracking of the controller based on images captured of the real-world environment by cameras on the controller. For each captured image, features may be identified and the pixel positions of the identified features may be compared to pixel positions of the same features in other images, allowing for the 6DOF pose of the controller to be calculated for each image. The second technique is referred to as “constellation tracking”, which is 6DOF pose tracking of the controller based on images captured of fiducials (e.g., light-emitting diodes (LEDs)) affixed to the controller by cameras on the headset. The fiducials may be programmed to flash (i.e., emit light) while the headset camera is exposed so that each captured image contains the flashed fiducials, which may then be identified by an imaging processing routine. The pixel positions of the identified fiducials in the images may be determined, and the identified fiducials may be associated with the fiducial's known geometry so that the 6DOF pose of the controller may be determined.

During operation of the wearable system, one or both of these controller pose tracking techniques may be used. For example, if controller inside-out tracking is unavailable (e.g., images of the environment do not include a sufficient number of features due to, e.g., low light conditions), the wearable system may rely on constellation tracking. Conversely, if constellation tracking is unavailable (e.g., controller fiducials are not within the headset camera's field of view), the wearable system may rely on controller inside-out tracking. Furthermore, if both tracking techniques are available, the tracking data produced by the two techniques may be fused together.

In conventional VR or AR systems, 6DOF pose tracking of a peripheral device is achieved by incorporating a series of electromagnetic sensors and emitters that are strategically placed on the user's AR headset, remote device, and/or other ancillary devices (e.g., totems, haptic devices, gaming instruments, etc.). Typically, electromagnetic tracking systems include at least one electromagnetic field emitter and at least one electromagnetic field sensor. Because the emitted electromagnetic fields have a known distribution, the detected fields may be analyzed to determine a position and/or orientation of the peripheral device. Although such systems offer a simple solution to the localization problem, there is a need for additional solutions that offer higher accuracy localization. Embodiments of the present disclosure can replace or supplement electromagnetic tracking systems.

When employed in an AR system, the 6DOF pose tracking information of the handheld device may facilitate the operation of the AR system. For example, the AR system may generate virtual content representing or interacting with the controller that feels comfortable to the user. For example, during a game in which multiple users play with a virtual ball and a virtual bat, the AR system may generate virtual content for the virtual bat that is accurately positioned and oriented with the controller of the user that is holding the bat.

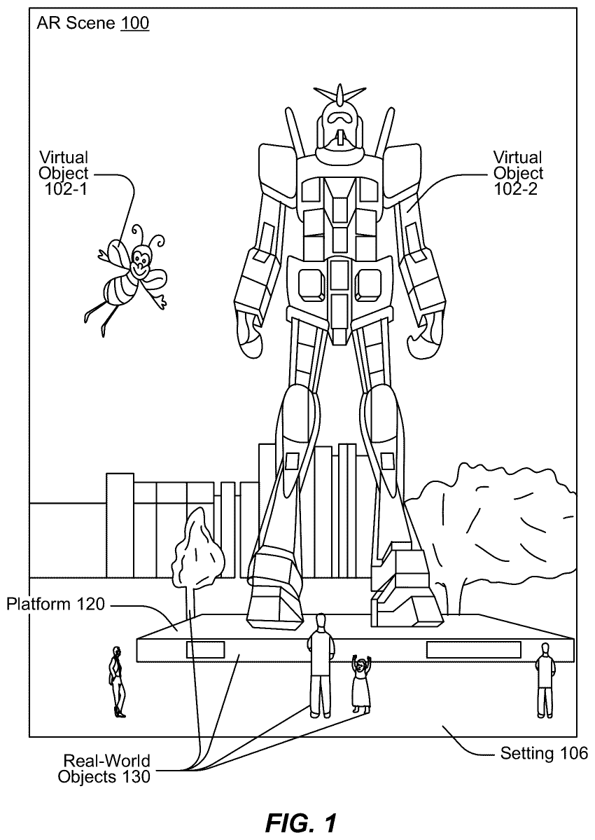

FIG. 1 illustrates an AR scene 100 as viewed through a wearable AR device, according to some embodiments of the present disclosure. The AR scene 100 is depicted wherein a user of an AR technology sees a real-world park-like setting 106 featuring various real-world objects 130 such as people, trees, buildings in the background, and a real-world concrete platform 120. In addition to these items, the user of the AR technology also perceives that they “see” various virtual objects 102 such as a robot statue 102-2 standing upon the real-world concrete platform 120, and a cartoon-like avatar character 102-1 flying by, which seems to be a personification of a bumble bee, even though these elements (character 102-1 and statue 102-2) do not exist in the real world. Due to the extreme complexity of the human visual perception and nervous system, it is challenging to produce a VR or AR technology that facilitates a comfortable, natural-feeling, rich presentation of virtual image elements amongst other virtual or real-world imagery elements.

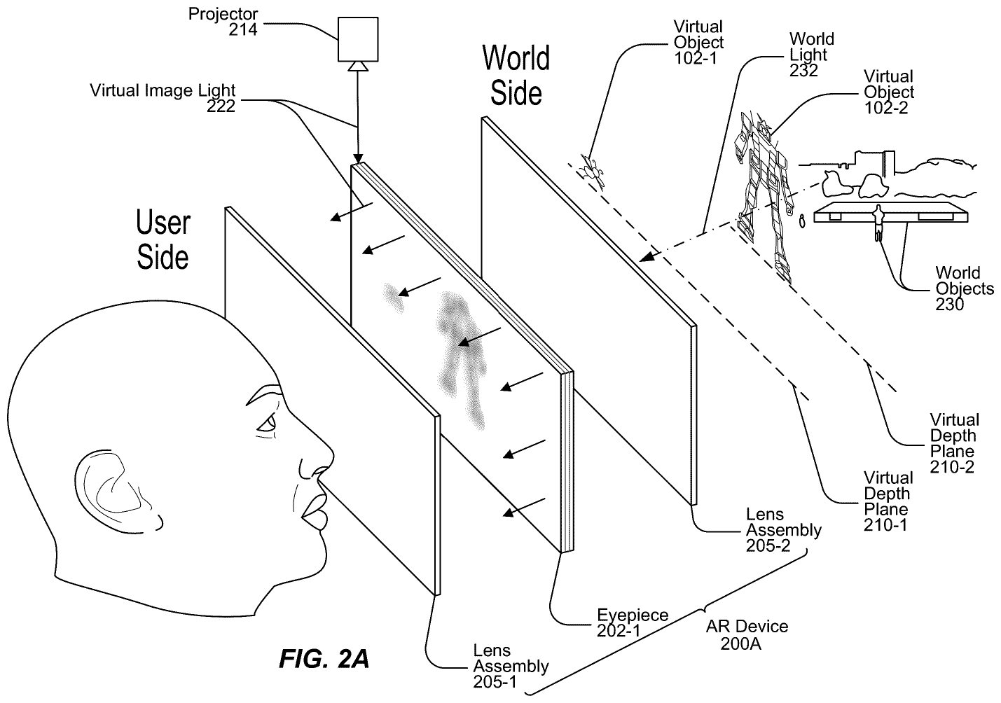

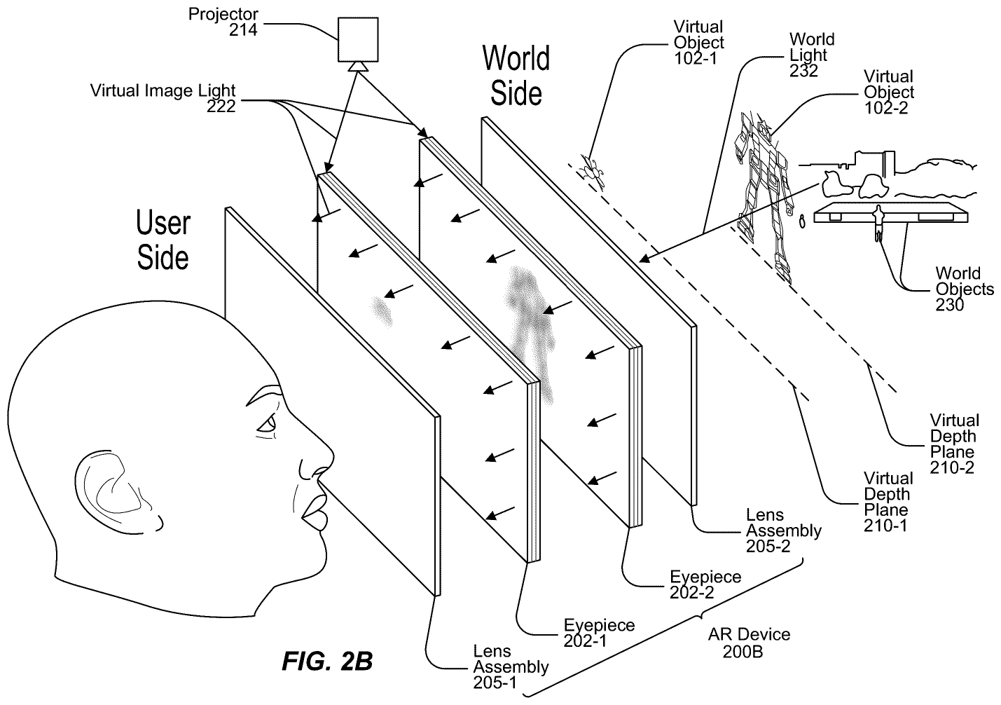

FIG. 2A illustrates an AR device 200A having a single fixed focal plane, according to some embodiments of the present disclosure. During operation, a projector 214 of the AR device 200A may project virtual image light 222 (i.e., light associated with virtual content) onto an eyepiece 202-1, which may cause a light field (i.e., an angular representation of virtual content) to be projected onto a retina of a user in a manner such that the user perceives the corresponding virtual content as being positioned at some location within an environment of the user. For example, the virtual image light 222 outcoupled by the eyepiece 202-1 may cause the user to perceive the character 102-1 as being positioned at a first virtual depth plane 210-1 and the statue 102-2 as being positioned at a second virtual depth plane 210-2. The user perceives the virtual content along with world light 232 corresponding to one or more world objects 230, such as the platform 120. In some embodiments, the AR device 200A includes a first lens assembly 205-1 positioned on the user side of the eyepiece 202-1 (the side of the eyepiece 202-1 closest to the eye of the user) and a second lens assembly 205-2 positioned on the world side of the eyepiece 202-1. Each of the lens assemblies 205-1, 205-2 may be configured to apply optical power to the light passing therethrough.

FIG. 2B illustrates an AR device 200B having two fixed focal planes, according to some embodiments of the present disclosure. During operation, the projector 214 may project the virtual image light 222 onto the first eyepiece 202-1 and a second eyepiece 202-2, which may cause a light field to be projected onto a retina of a user in a manner such that the user perceives the corresponding virtual content as being positioned at some location within an environment of the user. For example, the virtual image light 222 outcoupled by the first eyepiece 202-1 may cause the user to perceive the character 102-1 as being positioned at a first virtual depth plane 210-1 and the virtual image light 222 outcoupled by the second eyepiece 202-2 may cause the user to perceive the statue 102-2 as being positioned at a second virtual depth plane 210-2.

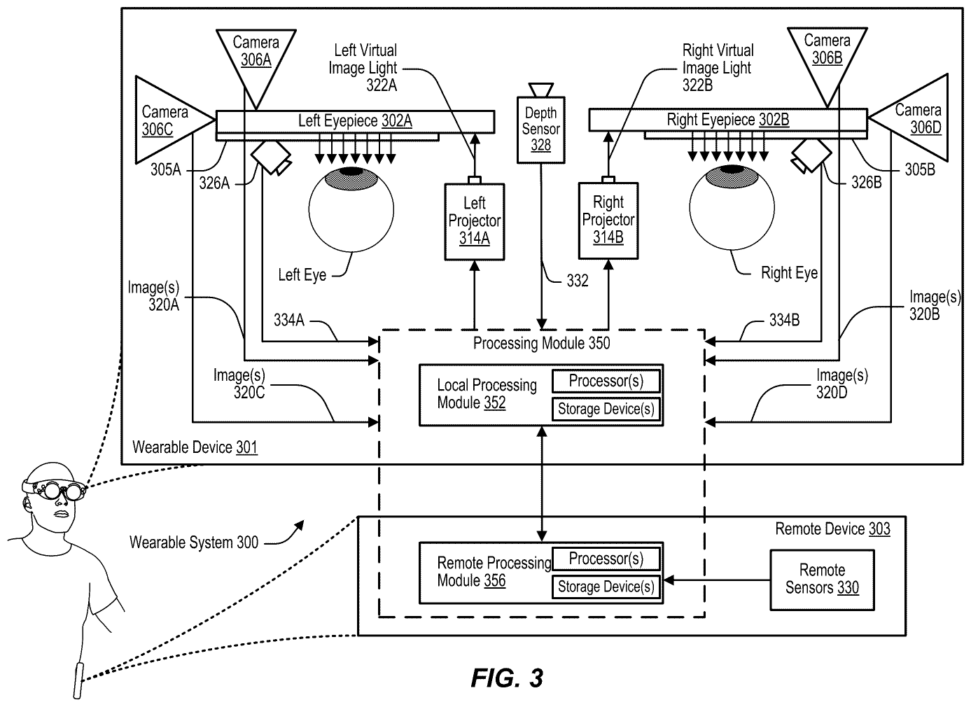

FIG. 3 illustrates a schematic view of an example wearable system 300, according to some embodiments of the present disclosure. The wearable system 300 may include a wearable device 301 and at least one remote device 303 that is remote from the wearable device 301 (e.g., separate hardware but communicatively coupled). While the wearable device 301 is worn by a user (generally as a headset), the remote device 303 may be held by the user (e.g., as a handheld controller) or mounted in a variety of configurations, such as fixedly attached to a frame, fixedly attached to a helmet or hat worn by a user, embedded in headphones, or otherwise removably attached to a user (e.g., in a backpack-style configuration, in a belt-coupling style configuration, etc.).

The wearable device 301 may include a left eyepiece 302A and a left lens assembly 305A arranged in a side-by-side configuration and constituting a left optical stack. The left lens assembly 305A may include an accommodating lens on the user side of the left optical stack as well as a compensating lens on the world side of the left optical stack. Similarly, the wearable device 301 may include a right eyepiece 302B and a right lens assembly 305B arranged in a side-by-side configuration and constituting a right optical stack. The right lens assembly 305B may include an accommodating lens on the user side of the right optical stack as well as a compensating lens on the world side of the right optical stack.

In some embodiments, the wearable device 301 includes one or more sensors including, but not limited to: a left front-facing world camera 306A attached directly to or near the left eyepiece 302A, a right front-facing world camera 306B attached directly to or near the right eyepiece 302B, a left side-facing world camera 306C attached directly to or near the left eyepiece 302A, a right side-facing world camera 306D attached directly to or near the right eyepiece 302B, a left eye tracking camera 326A directed toward the left eye, a right eye tracking camera 326B directed toward the right eye, and a depth sensor 328 attached between eyepieces 302. The wearable device 301 may include one or more image projection devices such as a left projector 314A optically linked to the left eyepiece 302A and a right projector 314B optically linked to the right eyepiece 302B.

The wearable system 300 may include a processing module 350 for collecting, processing, and/or controlling data within the system. Components of the processing module 350 may be distributed between the wearable device 301 and the remote device 303. For example, the processing module 350 may include a local processing module 352 on the wearable portion of the wearable system 300 and a remote processing module 356 physically separate from and communicatively linked to the local processing module 352. Each of the local processing module 352 and the remote processing module 356 may include one or more processing units (e.g., central processing units (CPUs), graphics processing units (GPUs), etc.) and one or more storage devices, such as non-volatile memory (e.g., flash memory).

The processing module 350 may collect the data captured by various sensors of the wearable system 300, such as the cameras 306, the eye tracking cameras 326, the depth sensor 328, the remote sensors 330, ambient light sensors, microphones, inertial measurement units (IMUs), accelerometers, compasses, Global Navigation Satellite System (GNSS) units, radio devices, and/or gyroscopes. For example, the processing module 350 may receive image(s) 320 from the cameras 306. Specifically, the processing module 350 may receive left front image(s) 320A from left front-facing world camera 306A, right front image(s) 320B from right front-facing world camera 306B, left side image(s) 320C from left side-facing world camera 306C, and right side image(s) 320D from right side-facing world camera 306D. In some embodiments, the image(s) 320 may include a single image, a pair of images, a video comprising a stream of images, a video comprising a stream of paired images, and the like. The image(s) 320 may be periodically generated and sent to the processing module 350 while the wearable system 300 is powered on, or may be generated in response to an instruction sent by the processing module 350 to one or more of the cameras.

The cameras 306 may be configured in various positions and orientations along the outer surface of the wearable device 301 so as to capture images of the user's surrounding. In some instances, the cameras 306A, 306B may be positioned to capture images that substantially overlap with the FOVs of a user's left and right eyes, respectively. Accordingly, placement of the cameras 306 may be near a user's eyes but not so near as to obscure the user's FOV. Alternatively or additionally, the cameras 306A, 306B may be positioned so as to align with the incoupling locations of the virtual image light 322A, 322B, respectively. The cameras 306C, 306D may be positioned to capture images to the side of a user, e.g., in a user's peripheral vision or outside the user's peripheral vision. The image(s) 320C, 320D captured using the cameras 306C, 306D need not necessarily overlap with the image(s) 320A, 320B captured using the cameras 306A, 306B.

In some embodiments, the processing module 350 may receive ambient light information from an ambient light sensor. The ambient light information may indicate a brightness value or a range of spatially-resolved brightness values. The depth sensor 328 may capture a depth image 332 in a front-facing direction of the wearable device 301. Each value of the depth image 332 may correspond to a distance between the depth sensor 328 and the nearest detected object in a particular direction. As another example, the processing module 350 may receive eye tracking data 334 from the eye tracking cameras 326, which may include images of the left and right eyes. As another example, the processing module 350 may receive projected image brightness values from one or both of the projectors 314. The remote sensors 330 located within the remote device 303 may include any of the above-described sensors with similar functionality.

Virtual content is delivered to the user of the wearable system 300 using the projectors 314 and the eyepieces 302, along with other components in the optical stacks. For instance, the eyepieces 302A, 302B may comprise transparent or semi-transparent waveguides configured to direct and outcouple light generated by the projectors 314A, 314B, respectively. Specifically, the processing module 350 may cause left projector 314A to output left virtual image light 322A onto left eyepiece 302A, and may cause right projector 314B to output right virtual image light 322B onto right eyepiece 302B. In some embodiments, the projectors 314 may include micro-electromechanical system (MEMS) spatial light modulator (SLM) scanning devices. In some embodiments, each of the eyepieces 302A, 302B may comprise a plurality of waveguides corresponding to different colors. In some embodiments, the lens assemblies 305A, 305B may be coupled to and/or integrated with the eyepieces 302A, 302B. For example, the lens assemblies 305A, 305B may be incorporated into a multi-layer eyepiece and may form one or more layers that make up one of the eyepieces 302A, 302B.

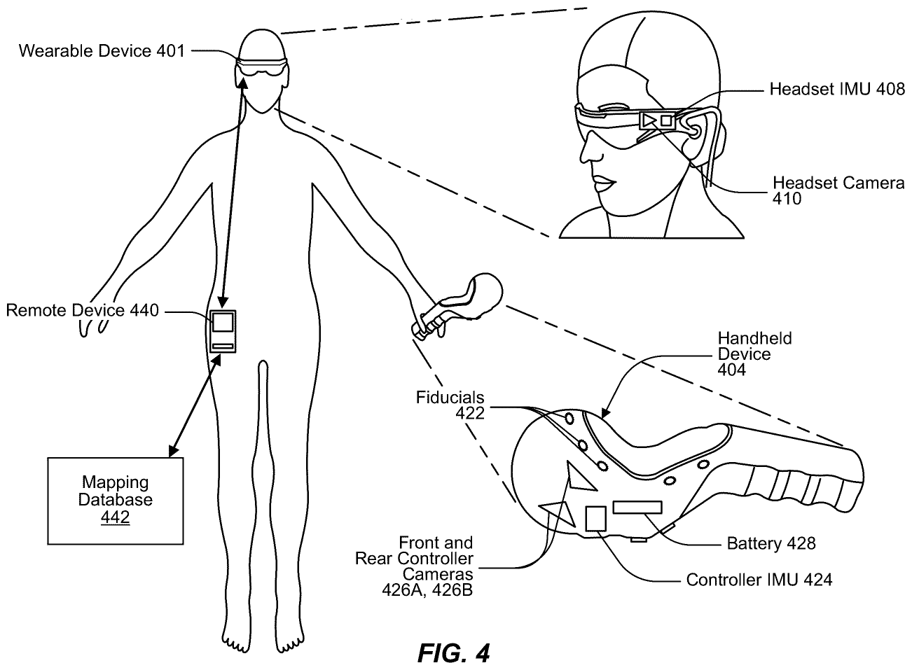

FIG. 4 illustrates an example of how a visual tracking system may be incorporated into an AR system having a wearable device 401 (e.g., a head set) and a handheld device 404 (e.g., a controller). In some embodiments, the handheld device 404 is a handheld controller that allows a user to provide an input to the AR system. For example, the handheld device 404 may be a totem to be used in a gaming scenario. The handheld device 404 may be a haptic device and may include one or more haptic surfaces utilizing a variety of sensor types. During operation of the AR system, a user may hold the handheld device 404 in his/her left or right hand by actively gripping the handheld device 404 and/or by securing an attachment mechanism (e.g., a wraparound strap) to the user's hand.

The handheld device 404 may include one or more fiducials 422 positioned along one or more exterior surfaces of the handheld device 404 such that the fiducials may be within the field of view of an imaging device external to the handheld device 404. The fiducials 422 may have a known geometric relationship with respect to each other such that an imaging device may determine its position and/or orientation with respect to the handheld device 404 by capturing an image of one or more of the fiducials 422. The fiducials 422 may be dynamic, static, electrically powered, unpowered, and may, in some embodiments, be distinguishable from each other. For example, a first fiducial may be an LED having a first wavelength and a second fiducial may be an LED having a second wavelength. Alternatively or additionally, different fiducials may have different brightness and/or may pulsate at different frequencies (e.g., a first fiducial may pulsate at 100 Hz and a second fiducial may pulsate at 150 Hz).

The handheld device 404 may include one or more imaging devices (referred to herein as controller cameras 426) positioned in a manner such that the wearable device 401 and/or some feature in the surroundings of the handheld device 404 is within the field of view(s) of the imaging device(s) when the handheld device 404 is being held by a user. For example, a front controller camera 426A may be positioned such that its field of view is oriented away from the user towards one or more features in the surroundings of the handheld device 404, and a rear controller camera 426B may be positioned such that its field of view is oriented towards the wearable device 401. The controller cameras 426 may include one or more front-facing imaging devices and/or one or more rear-facing imaging devices to create a desired cumulative field of view. In some embodiments, the controller cameras 426 may capture still or moving images.

The handheld device 404 may include an IMU (referred to herein as a controller IMU 424) that is rigidly secured within the handheld device 404 such that rotational and linear movement of the handheld device 404 is similarly experienced by the controller IMU 424. In some instances, the controller IMU 424 may include one or more accelerometers (e.g., three), one or more gyroscopes (e.g., three), one or more magnetometers (e.g., three), and/or digital signal processing hardware and software to convert raw measurements into processed data. For example, the controller IMU 424 may include an accelerometer, a gyroscope, and a magnetometer for each of three axes. For each axis, the controller IMU 424 may output one or more of: linear position, linear velocity, linear acceleration, rotational position, rotational velocity, and/or rotational acceleration. Alternatively or additionally, the controller IMU 424 may output raw data from which any of the above-mentioned forms of processed data may be calculated.

The handheld device 404 may comprise a rechargeable and/or replaceable battery 428 or other power supply that powers the fiducials 422, the controller cameras 426, the controller IMU 424, and any other components of the handheld device 404. Although not illustrated in FIG. 4, the handheld device 404 may include circuitry for enabling wireless communication with the wearable device 401 and/or the remote device 440. For example, upon detecting or capturing data using the controller cameras 426 and the controller IMU 424, the handheld device 404 may transmit raw or processed data to the wearable device 401 and/or the remote device 440.

The wearable device 401 may include one or more imaging devices (referred to herein as headset cameras 410) positioned in a manner such that the handheld device 404 including the fiducials 422 are within the field of view(s) of the imaging device(s) when the handheld device 404 is being held by a user. For example, one or more headset cameras 410 may be positioned front-facing on the wearable device 401 above, below, and/or to the side of an optical see-through component of the wearable device 401. In one embodiment, two headset cameras 410 may be positioned on opposite sides of the optical see-through component of the wearable device 401. In some embodiments, the headset cameras 410 may capture still or moving images.

The wearable device 401 may include a headset IMU 408 that is rigidly secured within the wearable device 401 such that rotational and linear movement of the wearable device 401 is similarly experienced by the headset IMU 408. In some instances, the headset IMU 408 may include one or more accelerometers (e.g., three), one or more gyroscopes (e.g., three), one or more magnetometers (e.g., three), and/or digital signal processing hardware and software to convert raw measurements into processed data. For example, the headset IMU 408 may include an accelerometer, a gyroscope, and a magnetometer for each of three axes. For each axis, the headset IMU 408 may output one or more of: linear position, linear velocity, linear acceleration, rotational position, rotational velocity, and/or rotational acceleration. Alternatively or additionally, the headset IMU 408 may output raw data from which any of the above-mentioned forms of processed data may be calculated.

In some embodiments, the AR system may include a remote device 440, which may include a computing apparatus (e.g., one or more processors and an associated memory) for performing a localization of the handheld device 404 with respect to the wearable device 401. Alternatively or additionally, the computing apparatus may reside in the wearable device 401 itself, or even the handheld device 404. The computing apparatus may receive (via a wired and/or wireless connection) raw or processed data from each of the headset IMU 408, the headset camera 410, the controller IMU 424, and the controller cameras 426, and may compute a geospatial position of the handheld device 404 (with respect to the geospatial position of the wearable device 401) and an orientation of handheld device 404 (with respect to the orientation of the wearable device 401). The computing apparatus may in turn comprise a mapping database 442 (e.g., passable world model, coordinate space, etc.) to detect pose, to determine the coordinates of real objects and virtual objects, and may even connect to cloud resources and the passable world model, in one or more embodiments. In some embodiments, images captured using the headset camera 410 and/or the controller cameras 426 may be used to build a passable world model. For example, features may be detected in the captured images, and the collected data (for example sparse points) may be used for building the passable world model or environmental maps otherwise.

In some embodiments, the controller 404 includes fiducials 422 positioned along one or more exterior surfaces of the controller 404 such that the fiducials may be within the field of view of an imaging device external to the controller 404. For instance, the controller 404 may include nine fiducials positioned on a top surface of the controller 404 and two fiducials positioned on opposite sides of the controller 404. The two fiducials on the sides of the controller 404 may be positioned proximate to the controller cameras 426. In other examples, the controller 404 may include more or fewer fiducials 422. The fiducials 422 may have a known geometry such that an imaging device may determine its position and/or orientation with respect to the controller 404 by capturing an image of one or more of fiducials 422. As illustrated, the fiducials 422 on the top surface are arranged in a circle, but other configurations are possible.

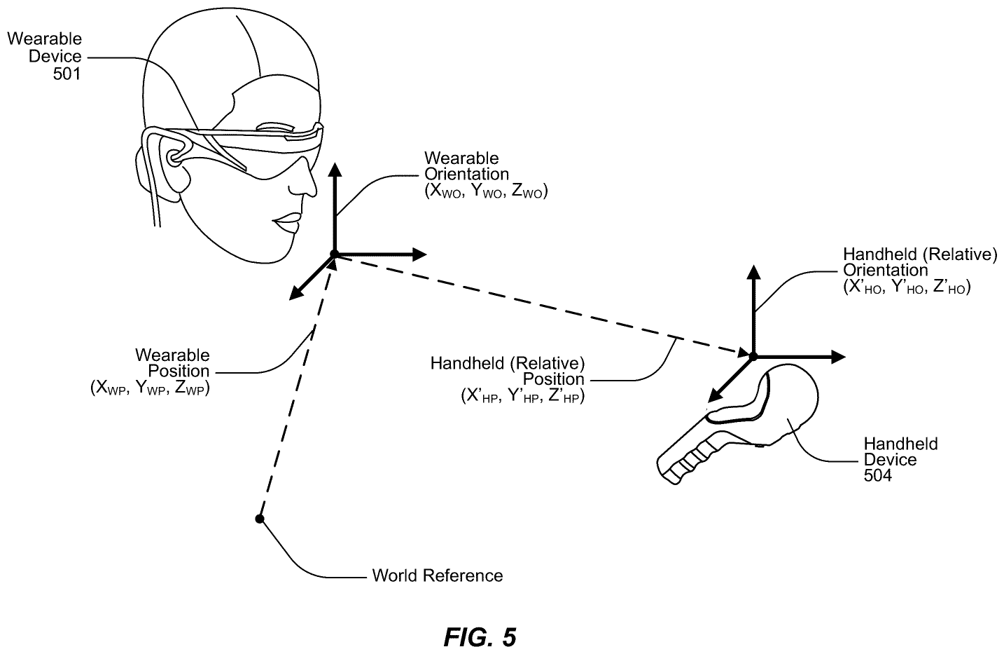

FIG. 5 illustrates a diagram of the localization task, as performed by an AR system, in which the position and the orientation of a handheld device 504 are determined with respect to a wearable device 501. In the illustrated diagram, the wearable device 501 has a geospatial position (“wearable position”) defined as (X_{WP}, Y_{WP}, Z_{WP}) with respect to a world reference and an orientation (“wearable orientation”) defined as (X_{WO}, Y_{WO}, Z_{WO}) with respect to a world reference. In some instances, the geospatial position of the wearable device 501 is expressed in longitude, latitude, and elevation values and the orientation of the wearable device 501 is expressed in pitch angle, yaw angle, and roll angle values.

As illustrated, the handheld device 504 has a geospatial position (“handheld position”) defined as (X′_{HP}, Y′_{HP}, Z′_{HP}) with respect to the geospatial position of the wearable device 501 (X_{WP}, Y_{WP}, Z_{WP}) and an orientation (“handheld orientation”) defined as (X′_{HO}, Y′_{HO}, Z′_{HO}) with respect to the orientation of the wearable device 501 (X_{WO}, Y_{WO}, Z_{WO}). In some instances, the geospatial position of the handheld device 504 is expressed in X, Y, and Z Cartesian values and the orientation of the handheld device 504 is expressed in pitch angle, yaw angle, and roll angle values. As one specific example, when the handheld device 504 is being held by a user, the geospatial position of the handheld device 504 may be equal to (0.7 m, −0.5 m, 0.1 m) and the orientation of the handheld device 504 may be equal to (10.2°, −46.2°, 15.2°).

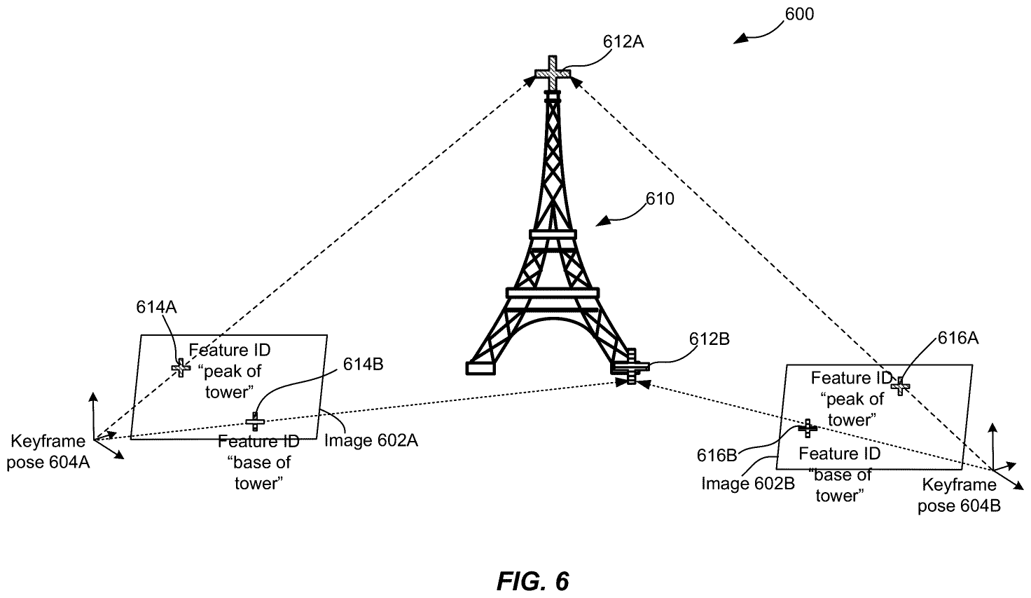

FIG. 6 illustrates a diagram of feature mapping from images 602 of an environment 600. In some embodiments, both a headset (e.g., wearable devices 301, 401, and 501) and a controller (e.g., handheld devices 404 and 504) can build and store a map of the environment 600 that includes a set of map points 612. Each map point is a three-dimensional (3D) point in the environment 600 corresponding to a particular feature (e.g., the corner of a table, the corner of a door, a center point of a wall, etc.). The map may further include a map point identifier (ID) for each map point (e.g., #1, #2, #3, etc.) and a feature ID for each feature and map point (e.g., “corner of table”, “corner of door”, etc.). The map may further include a list of keyframe poses and a corresponding list of 2D feature points for each map point. For example, a particular map point for a particular feature (e.g., “corner of table”) may have been identified in 20 different images captured by one or both of the left and right-facing cameras, and may therefore have 20 keyframe poses (the 6DOF pose of the camera) and 20 two-dimensional (2D) feature points (the 2D position within the image, i.e., the pixel positions).

In FIG. 6, the environment 600 includes a tower 610 with map points 612A-612B, which correspond to a peak and a base of the tower 610, respectively. A controller can capture images 602A-602B of the environment 600 and identify features in the images 602A-602B. Image 602A includes features 614A-614B, where feature 614A corresponds to the peak of the tower 610 and feature 614B corresponds to the base of the tower 610. Image 602B includes features 616A-616B, where feature 616A corresponds to the peak of the tower 610 and feature 616B corresponds to the base of the tower 610. Accordingly, features 614A and 616A include a feature ID of “peak of tower” and features 614B and 616B include a feature ID of “base of tower”. Keyframe pose 604A indicates a 6DOF pose of the camera when image 602A was captured and keyframe pose 604B indicates a 6DOF pose of the camera when image 602B was captured.

When the controller is building the map containing map points 612, the pose of the controller can be tracked using constellation tracking so that the 3D map points that the controller generates can be established in the proper reference frame, e.g., the reference frame of the headset. Thereafter, the controller can perform controller inside-out tracking with the correct scale and alignment.

In some instances, 6DOF pose tracking of the headset can be performed using images captured by cameras of the headset in combination with the headset IMU. This technique is referred to as headset inside-out tracking. For each captured image, features may be identified and the pixel positions of the identified features may be compared to pixel positions of the same features in other images, allowing for the 6DOF pose of the headset to be calculated for each image.

In some instances, 6DOF pose tracking of the controller can be performed using one or both of two separate techniques. The first technique is (1) controller inside-out tracking, which is 6DOF pose tracking of the controller based on images captured of the real-world environment by controller cameras on the controller. Similar to headset inside-out tracking, for each captured image, features may be identified and the pixel positions of the identified features may be compared to pixel positions of the same features in other images, allowing for the 6DOF pose of the controller to be calculated for each image. The second technique is (2) constellation tracking, which is 6DOF pose tracking of the controller based on images captured of fiducials (e.g., LEDs) affixed to the controller by cameras on the headset. The 6DOF pose of the controller can be calculated from an image of the controller captured by a headset camera. The image may be any single frame in which at least three of the fiducials are visible. During operation of the wearable system, one or both of these techniques may be used. For example, if controller inside-out tracking is unavailable (e.g., images of the environment do not include a sufficient number of features due to, e.g., low light conditions), the wearable system may rely on constellation tracking. Conversely, if constellation tracking is unavailable (e.g., controller fiducials are not within the headset camera's field of view), the wearable system may rely on controller inside-out tracking. Furthermore, if both tracking techniques are available, the tracking data produced by the two techniques may be fused together.

Inside-out tracking may need to be initialized with a correct scale and alignment with respect to the headset, so constellation tracking can be used to build a map of map points (e.g., map points 612A-612B) with an accurate scale and alignment to the environment 600.

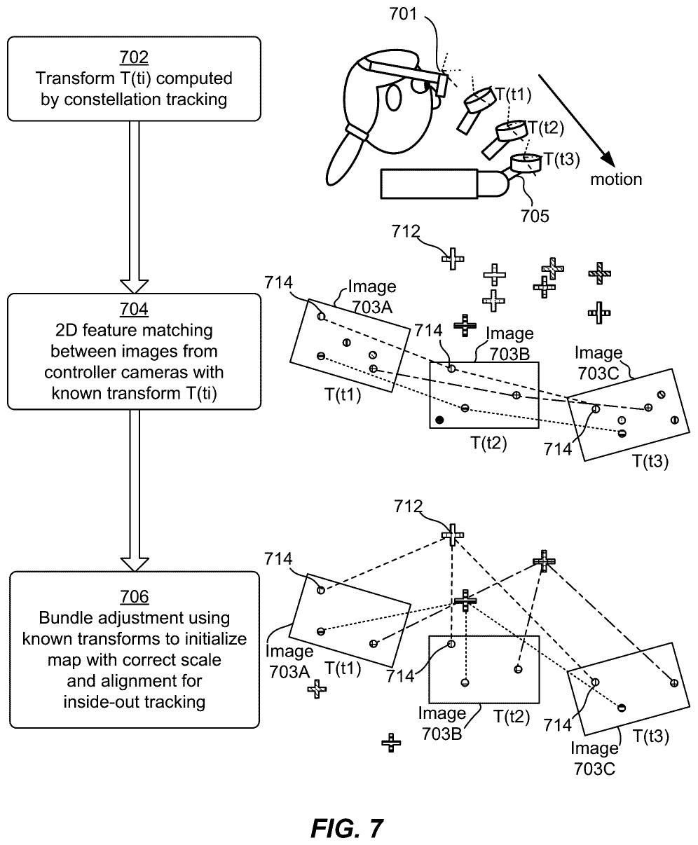

FIG. 7 illustrates an exemplary flowchart and corresponding diagrams of using constellation tracking to generate map points of an environment. At block 702, a headset 701 (e.g., wearable devices 301, 401, and 501) computes a transform T (ti) using constellation tracking. So, headset cameras of the headset 701 capture images of a controller 705 (e.g., handheld devices 404 and 504) as the controller 705 is in motion and controller cameras of the controller 705 captures images 703A-703C of an environment surrounding the controller 705. Fiducials on the controller 705 can be flashing as the headset cameras image the controller 705. The headset 701 can identify the fiducials in the images, which can allow the headset 701 to determine a pose of the controller 705 with respect to the headset 701 when each of the images 703A-703C was taken. So, the transforms can represent the position and orientation of the controller 705 with respect to the headset 701 at time instances when each of the images 703A-703C were captured. Each of the transforms can have a correct scale. The headset 701 can then send the transforms to the controller 705, which can associate the transforms to each of the images 703A-703C.

At block 704, the controller 705 can perform 2D feature matching between the images 703A-703C with the known transforms. The controller 705 can identify features in each of the images 703A-703C. For instance, the controller 705 may perform image recognition or some other technique to identify features. A 2D feature point 714 (e.g., a corner of a door) can be identified as being in each of the images 703A-703C. So, 2D feature point 714 can be determined to correspond to a map point 712 in the environment.

At block 706, the controller 705 performs bundle adjustment using the known transforms to initialize a map with a correct scale and alignment for inside-out tracking. The controller 705 can triangulate the 2D feature points 714 in each of the images 703A-703C using the known transforms to determine a position of a corresponding map point 712 in the environment. The controller 705 can perform a similar bundle adjustment and triangulation technique for any matching 2D features points in the images 703A-703C. As a result, the controller 705 generates a map of 3D map points 712 that has a correct scale and alignment that can be used to determine a pose of the controller 705 in the environment.

FIG. 8 illustrates an example method 800 of using constellation tracking to determine map points, according to some embodiments of the present invention. One or more steps of method 800 may be performed in a different order than the illustrated embodiment, and one or more steps of method 800 may be omitted during performance of method 800. Furthermore, two or more steps of method 800 may be performed simultaneously or concurrently with each other.

At step 802, a set of fiducials of a controller are caused to flash. The set of fiducials are arranged in a known geometry (e.g., a circle). A headset may send instructions to the controller to indicate when the set of fiducials are to flash. In some instances, the instructions may indicate a subset of the fiducials that are to flash, a period or frequency at which the fiducials are to flash, or any other suitable parameter for the flashing.

At step 804, a pose of the controller is tracked. To track the pose, a set of headset images is captured using a headset camera of the headset. The headset images can include the set of fiducials if the controller is in the field of view of the headset camera. The set of fiducials can be identified in the headset images. Then, the pose of the controller can be tracked based on the identified set of fiducials in the set of headset images and based on a pose of the headset. For instance, the headset may determine a pose of the headset based on measurements of an inertial measurement unit of the headset. So, based on the pose of the headset and the set of fiducials, the pose of the controller with respect to the headset can be determined.

At step 806, a set of controller images is captured using a controller camera of the controller. The set of controller images may be captured while the pose of the controller is being tracked. The controller camera can capture the set of controller images of an environment surrounding the controller. A set of transforms may be generated that represent a position and an orientation of the controller relative to the headset at a set of time instances corresponding to when each of the set of controller images was captured. The set of transforms can be associated with the set of images.

At step 808, the set of two-dimensional feature points in each controller image of the set of controller images is identified. The two-dimensional feature points may be pixel locations in the controller images that correspond to three-dimensional features (e.g., a corner of a table, a corner of a window, etc.) in the environment.

At step 810, a set of three-dimensional map points is determined based on the set of two-dimensional feature points and the pose of the controller. A location of a three-dimensional map point may be determined by triangulating a two-dimensional feature point of the set of two-dimensional feature points in each of the set of controller images using the set of transforms. A map can be generated using the set of three-dimensional map points. The map can include a map point identifier and a feature identifier associated with each three-dimensional map point of the set of three-dimensional map points. In addition, the map can include a list of keyframe poses and a corresponding list of the set of two-dimensional feature points for each three-dimensional map point of the set of three-dimensional map points.

FIG. 9 illustrates a diagram showing example steps for determining a pose of a controller without a headset performing constellation tracking. Both a headset 901 and a controller 904 can build and store a map 910A-910B, respectively, that includes a set of map points 912. Each map point 912 is a 3D point in the environment corresponding to a particular feature (e.g., the corner of a table, the corner of a door, a center point of a wall, etc.). The maps 910A-910B may further include a map point ID for each map point 912 (e.g., #1, #2, #3, etc.) and a feature identifier for each feature and map point 912 (e.g., “corner of table”, “corner of door”, etc.). The maps 910A-910B may further include a list of keyframe poses and a corresponding list of 2D feature points for each map point 912. For example, a particular map point 912 for a particular feature (e.g., “corner of table”) may have been identified in 20 different images captured by one or both of the left and right-facing cameras of the headset 901 or the controller 904, and may therefore have 20 keyframe poses (the 6DOF pose of the camera) and 20 2D feature points (the 2D position within the image).

The map 910A that the headset 901 builds can be shared with the controller 904, and likewise the map 910B that the controller 904 builds can be shared with the headset 901. In FIG. 9, the headset 901 builds a map 910A that is shared with the controller 904. The headset 901 generates the map 910A at the correct scale (e.g., by using IMUs, stereo cameras, depth sensors, Lidars, etc.) and transmits the map 910A to the controller 904 in a compatible format. The headset 901 may transmit the map 910A via Bluetooth or another wireless connection. When the controller 904 receives the headset's map 910A, the controller 904 can localize itself with respect to the map 910A by performing controller inside-out tracking. This may include identifying the same features in the headset images that are included in the headset's map 910A (e.g., “corner of table”) to generate the map 910B. Alternatively, when the headset 901 receives the controller's map 910B, the headset 901 can localize itself with respect to the map 910B by performing headset inside-out tracking and identifying the same features in the controller images that are included in the controller's map 910B to generate the map 910A.

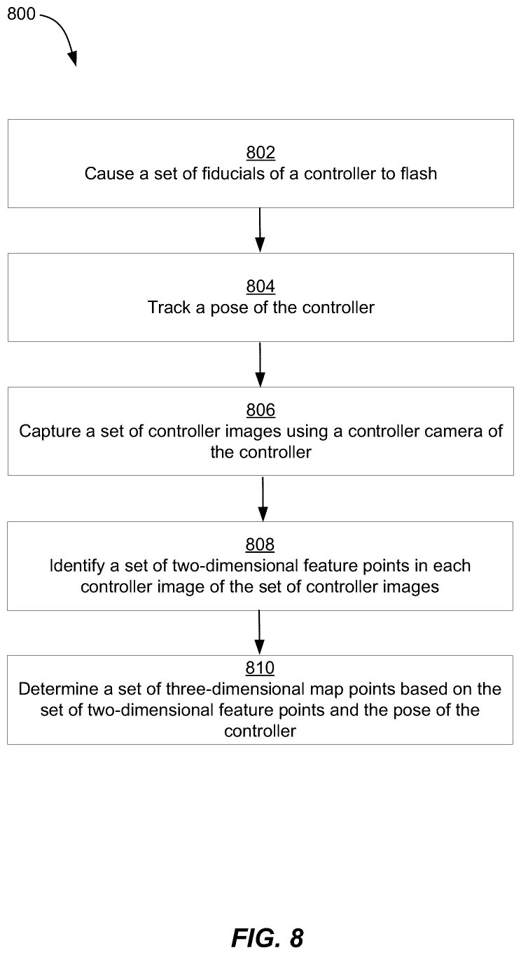

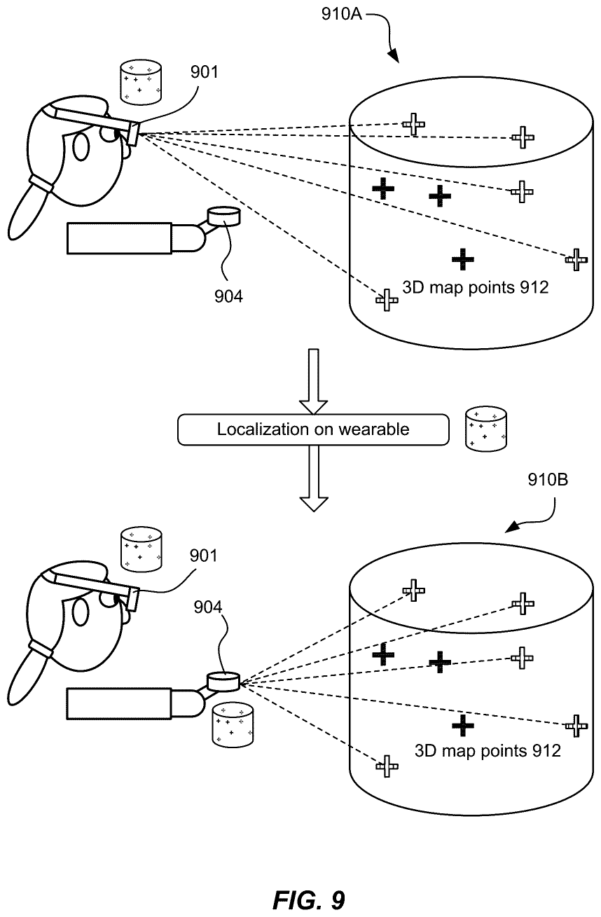

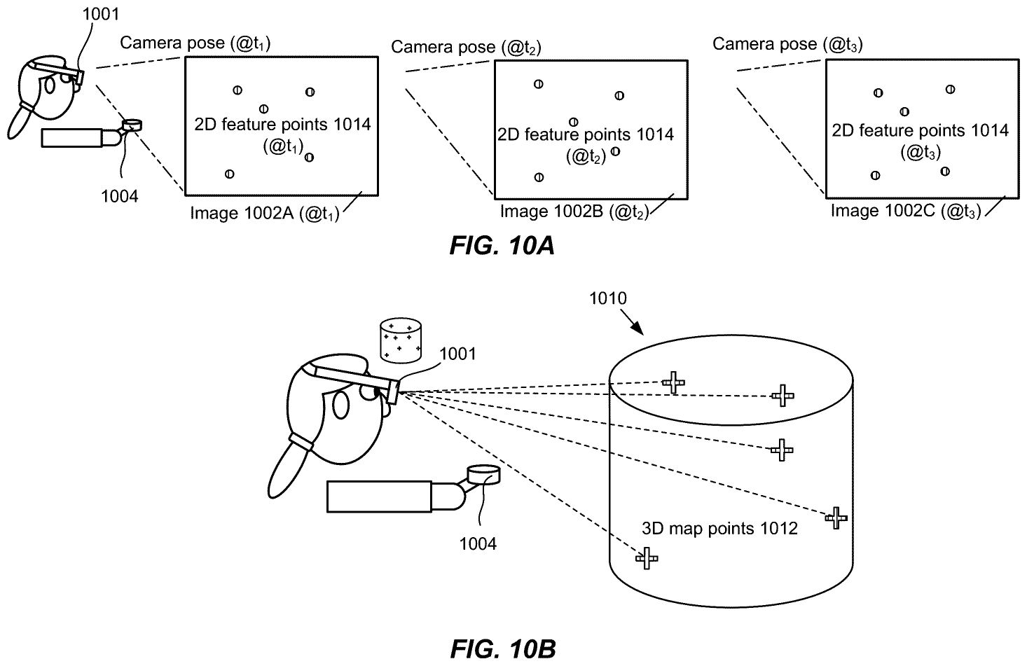

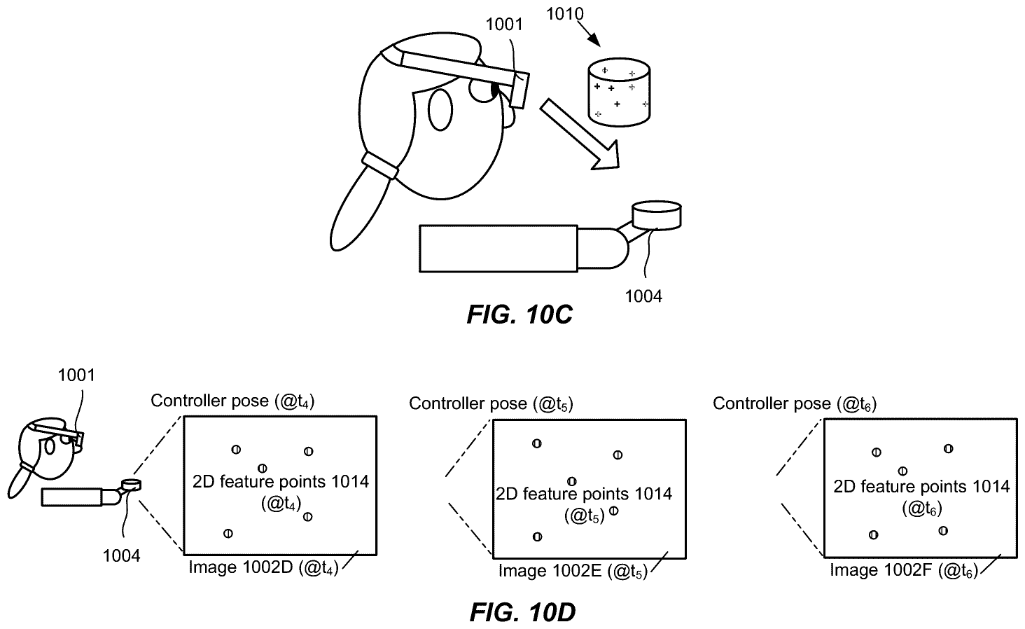

FIGS. 10A-10D illustrate a process of using map points to determine a pose of a controller of a wearable system. In FIG. 10A, a headset camera of a headset 1001 captures images 1002A-1002C and identifies 2D feature points 1014 in each image 1002. That is, each of the images 1002A-1002C can depict each of the 2D feature points 1014. So, the 2D feature points 1014 of the images 1002A-1002C may all represent that same five map points.

In FIG. 10B, the headset 1001 can build a map 1010 with 3D map points 1012 for the 2D feature points 1014. In addition, the map 1010 can include feature IDs that serve as labels for the 3D map points 1012. For instance, a first 3D map point may have a feature ID of “top of lamp” and a second 3D map point may have a feature ID of “bottom of lamp”. For each 2D feature point in the images 1002A-1002C, the headset 1001 can triangulate the position of the 2D feature point in each of the images 1002A-1002C to determine a position of the 2D feature point in space. Since the headset 1001 knows the poses of the headset 1001 when the images 1002A-1002C were taken, the headset 1001 can use the poses and the 2D feature points 1014 to determine the position and alignment of the 3D map points 1012 in the map 1010.

In FIG. 10C, the headset 1001 transmits the map 1010 to the controller 1004. The headset 1001 may use Bluetooth or another wireless connection to transmit the map 1010 to the controller 1004. In FIG. 10D, the controller camera captures images 1002D-1002F and identifies 2D feature points 1014 in each of the images 1002D-1002F. The 2D feature points 1014 can correspond to the five feature points from the images 1002A-1002C that were captured by the headset 1001. Upon identifying the 2D feature points 1014, the controller 1004 can determine its pose using the 3D map points 1012 in the map 1010 received from the headset 1001 and the 2D feature points 1014. The controller 1004 can localize itself with respect to the map 1010 by performing controller inside-out tracking by identifying the 2D feature points 1014 that are included in the map 1010 in the images 1002D-1002F.

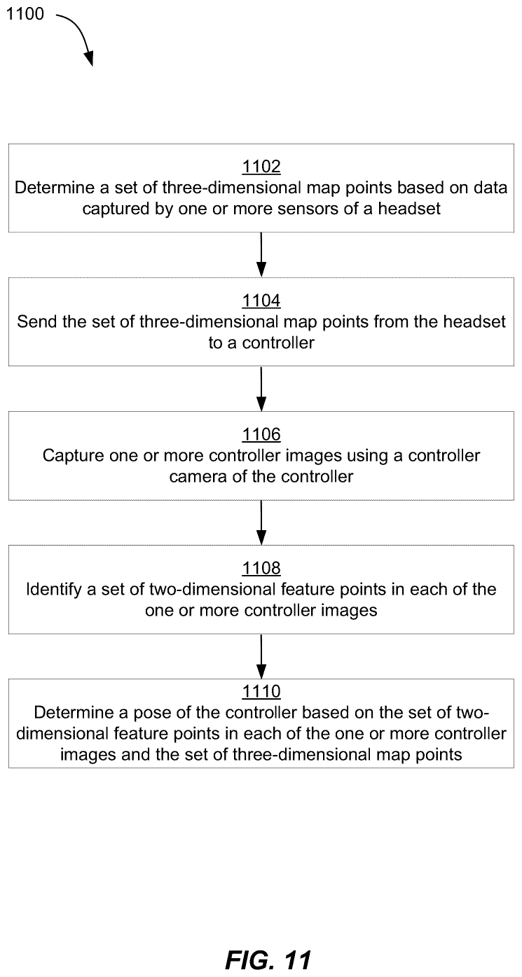

FIG. 11 illustrates an example method 1100 of using map points to determine a pose of a controller of a wearable system, according to some embodiments of the present invention. One or more steps of method 1100 may be performed in a different order than the illustrated embodiment, and one or more steps of method 1100 may be omitted during performance of method 1100. Furthermore, two or more steps of method 1100 may be performed simultaneously or concurrently with each other.

At step 1102, a set of three-dimensional map points is determined based on data captured by one or more sensors of a headset. The sensors may include a left front-facing world camera, a right front-facing world camera, a left side-facing world camera, a right side-facing world camera, a depth sensor, and/or an IMU. The data may include headset images generated by a headset camera of the headset. Two-dimensional feature points can be identified in the headset images, and three-dimensional map points corresponding to the two-dimensional feature points can be generated.

At step 1104, the set of three-dimensional map points is sent from the headset to a controller. The controller may not include a map of map points representing an environment in which the controller is positioned.

At step 1106, one or more controller images is captured using a controller camera of the controller. The one or more controller images depict the environment surrounding the controller. One or more of the map points included in the set of three-dimensional map points may be shown in the one or more controller images.

At step 1108, a set of two-dimensional feature points in each of the one or more controller images is identified. The two-dimensional feature points can correspond to the two-dimensional feature points identified in the headset images (and the one or more map points shown in the one or more controller images).

At step 1110, a pose of the controller is determined based on the set of two-dimensional feature points in each of the one or more controller images and the set of three-dimensional map points. One or more of the two-dimensional feature points can be determined that correspond to one or more of the set of three-dimensional map points. Based on the received three-dimensional map points and the identified corresponding two-dimensional features, the pose of the controller can be determined. A map that includes the set of three-dimensional map points can be stored on the controller and/or the headset. Each map point map can include a map point identifier and a feature identifier associated with each three-dimensional map point of the set of three-dimensional map points.

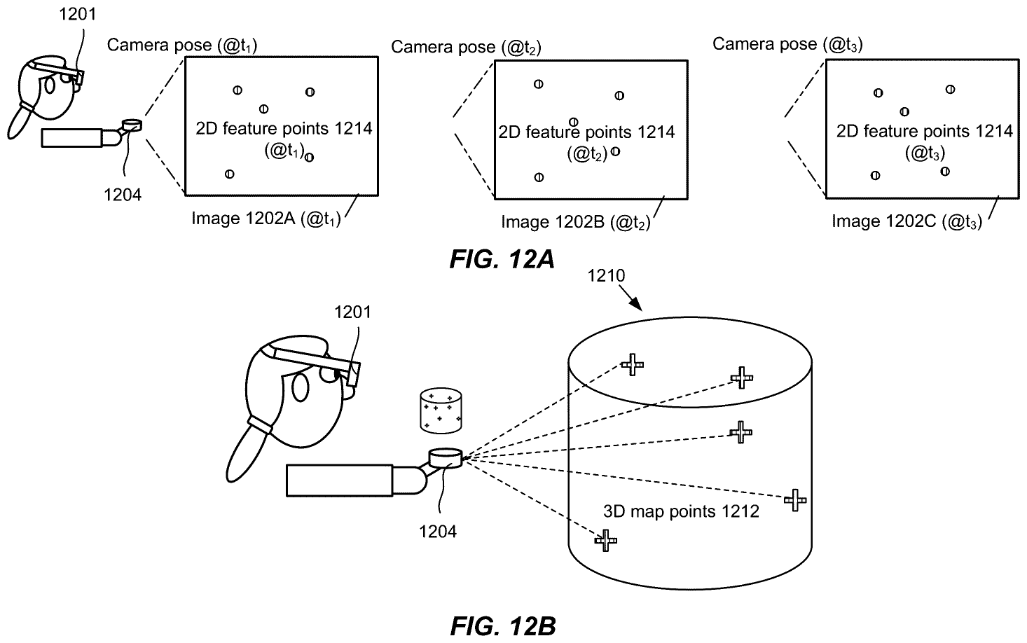

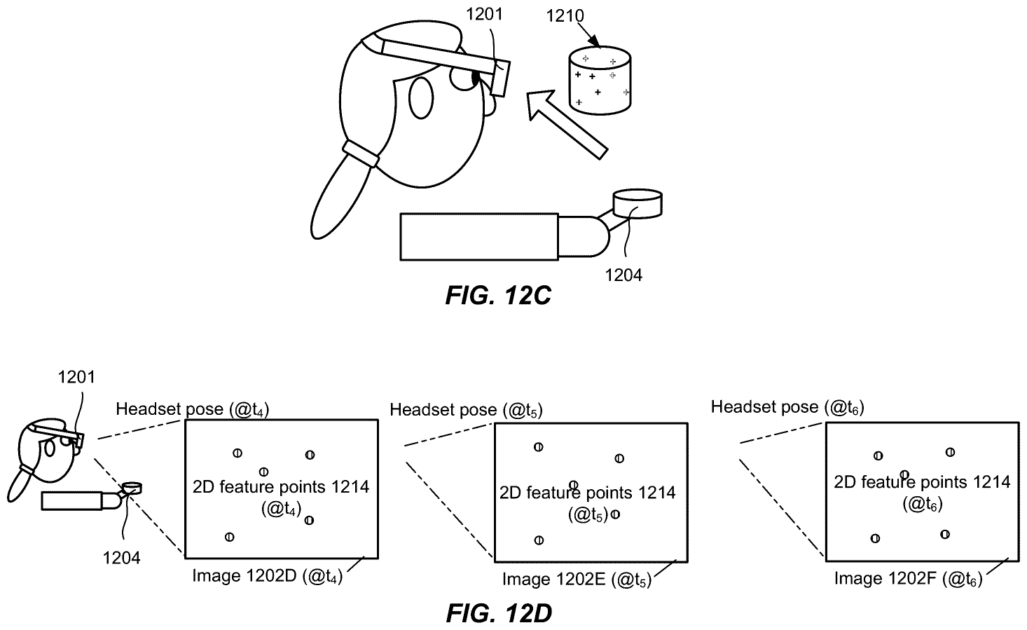

FIGS. 12A-12D illustrate a process of using map points to determine a pose of a headset of a wearable system. In FIG. 12A, a controller camera of a headset controller 1204 captures images 1202A-1202C and identifies 2D feature points 1214 in each image 1202. That is, each of the images 1202A-1202C can depict the 2D feature points 1214. So, the 2D feature points 1214 of the images 1202A-1202C may all represent that same five map points.

In FIG. 12B, the controller 1204 can build a map 1210 with 3D map points 1212 for the 2D feature points 1214. In addition, the map 1210 can include feature IDs that serve as labels for the 3D map points 1212. For instance, a first 3D map point may have a feature ID of “top of lamp” and a second 3D map point may have a feature ID of “bottom of lamp”. For each 2D feature point in the images 1202A-1202C, the controller 1204 can triangulate the position of the 2D feature point in each of the images 1202A-1202C to determine a position of the 2D feature point in space. Since the controller 1204 knows the pose of the controller camera when the images 1202A-1202C were taken, the controller 1204 can use the poses and the 2D feature points 1214 to determine the position and alignment of the 3D map points 1212 in the map 1210.

In FIG. 12C, the controller 1204 transmits the map 1210 to the headset 1201. The controller 1204 may use Bluetooth or another wireless connection to transmit the map 1210 to the headset 1201. In FIG. 12D, the headset camera of the headset 1201 captures images 1202D-1202F and identifies 2D feature points 1214 in each of the images 1202D-1202F. The 2D feature points 1214 can correspond to the five feature points from the images 1202A-1202C that were captured by the controller 1204. Upon identifying the 2D feature points 1214, the headset 1201 can determine its pose using the 3D map points 1212 in the map 1210 received from the controller 1204 and the 2D feature points 1214. The headset 1201 can localize itself with respect to the map 1210 by performing headset inside-out tracking by identifying the 2D feature points 1214 that are included in the map 1210 in the images 1202D-1202F.

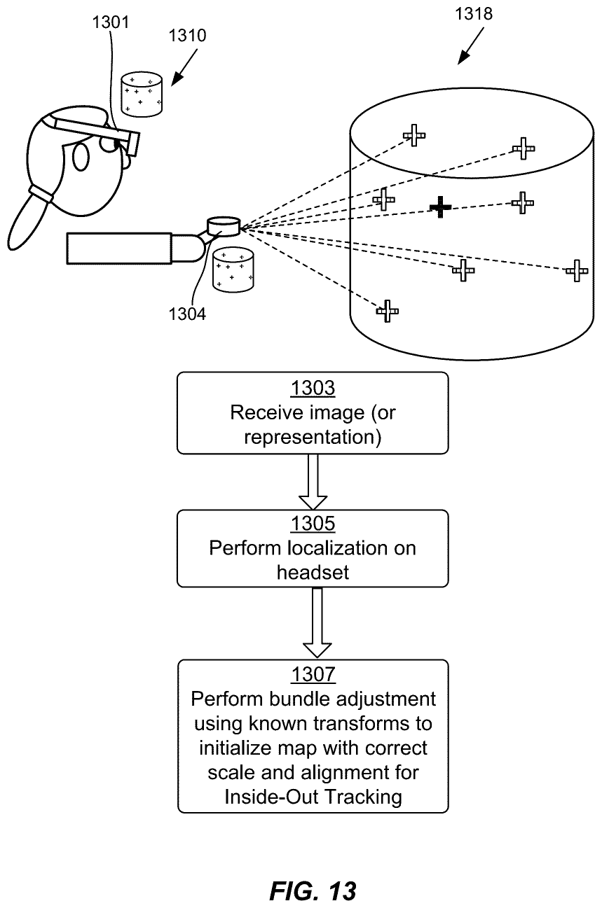

FIG. 13 illustrates a process of a headset localizing a controller from image features and map points. At block 1303, a headset 1301 receives an image or a representation of an image from a controller 1304. A controller camera of the controller 1304 can capture an image of an environment surrounding the controller 1304. The controller 1304 can then send the image to the headset 1301 that stores a map 1310 of the environment. Alternatively, rather than sending the image, the controller 1304 may extract features 1318 from the image and send the features 1318 to the headset 1301 as a representation of the image.

At block 1305, the headset 1301 performs localization. Using the features 1318 (or the image), the headset 1301 can localize the controller 1304 in the map 1310. The headset 1301 can then inform the controller 1304 of its location. In addition, at block 1307, the headset 1301 can perform bundle adjustment using known transforms to initialize a map for the controller 1304 with a correct scale and alignment for inside-out tracking. The headset 1301 may send the map to the controller 1304 so that the controller 1304 can localize itself within the environment. Alternatively, the headset 1301 may maintain the map and receive images and/or features from the controller 1304 to continue localizing the controller 1304 using the map.

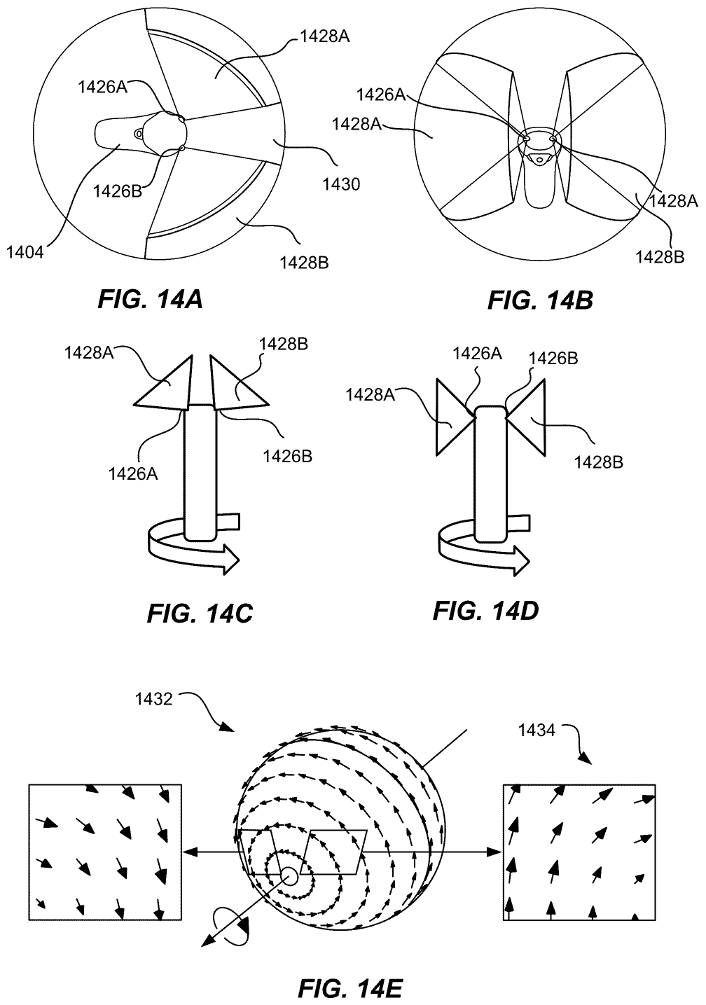

FIGS. 14A-14E illustrate aspects of controller cameras for reducing motion blur in images. In constellation tracking and visual inertial odometry (VIO) on a controller 1404, constellation tracking can be replaced with electromagnetic tracking. VIO is agnostic to material properties of the environment and electromagnetic tracking is agnostic to illumination of the environment, which may provide improvements to tracking. In general, it may be difficult to calculate a pose of the controller 1404 under fast rotational and translational motion. In addition, controller cameras 1426A-1426B may be required to see enough static texture in the environment. To solve this, the controller cameras 1426A-1426B may be non-overlapping wide-angle cameras that maximize a field of view 1428 to decrease a possibility of not seeing static texture. Duo-camera simultaneous localization and mapping (SLAM) algorithms may be used instead of stereo SLAM algorithms. As a result, motion blur in images may be reduced.

FIGS. 14A-14D illustrate fields of views 1428A-1428B of controller cameras 1426A-1426B. Each field of view 1428 is illustrated as being ninety degrees, for a total field of view of one-hundred eighty degrees around the controller 1404. In addition, there is a gap 1430 between the field of view 1428A of the controller camera 1426A and the field of view 1428B of the controller camera 1426B. In some embodiments, the gap 1430 may be larger or smaller. Since a fast motion roll may not yield a maximum rotational velocity with this configuration, the controller 1404 may be less affected by roll-induced motion blur, as shown in FIG. 14E, which illustrates an example of motion blur 1432 seen by controller cameras under roll. While FIGS. 14C-14D illustrate non-overlapping field of view configurations, the configuration shown in FIG. 14C may perform better under fast roll compared to the configuration shown in FIG. 14D. With the controller cameras 1426A-1426B positions of FIG. 14C, the motion blur 1432 seen by the controller cameras 1426A-1426B corresponds to area 1434, where the motion blur is smaller compared to other positions.

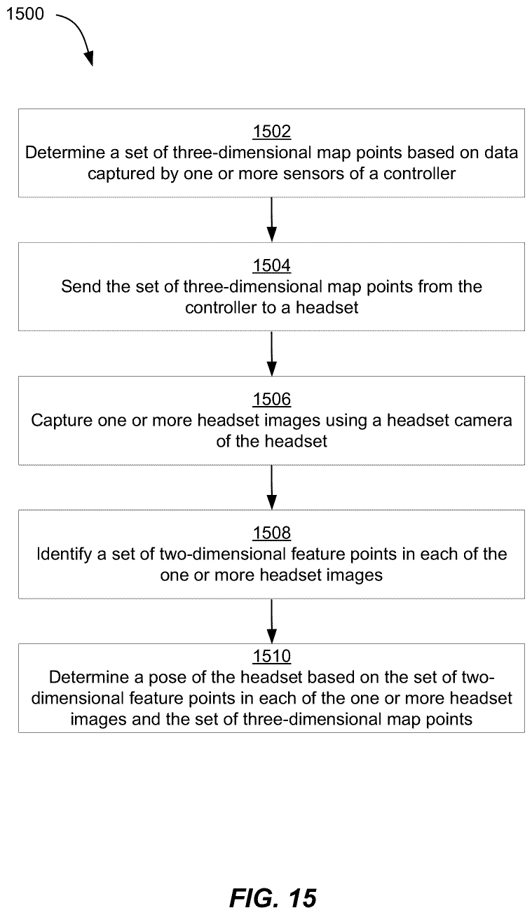

FIG. 15 illustrates an example method 1500 of using map points to determine a pose of a headset of a wearable system, according to some embodiments of the present invention. One or more steps of method 1500 may be performed in a different order than the illustrated embodiment, and one or more steps of method 1500 may be omitted during performance of method 1500. Furthermore, two or more steps of method 1500 may be performed simultaneously or concurrently with each other.

At step 1502, a set of three-dimensional map points is determined based on data captured by one or more sensors of a controller. The sensors may include a front controller camera, a rear controller camera, and/or an IMU. The data may include controller images generated by a controller camera of the controller. Two-dimensional feature points can be identified in the controller images, and three-dimensional map points corresponding to the two-dimensional feature points can be generated.

At step 1504, the set of three-dimensional map points is sent from the controller to a headset. The headset may not include a map of map points representing an environment in which the headset is positioned.

At step 1506, one or more headset images is captured using a headset camera of the headset. The one or more headset images depict the environment surrounding the headset. One or more of the map points included in the set of three-dimensional map points may be shown in the one or more headset images.

At step 1508, a set of two-dimensional feature points in each of the one or more controller images is identified. The two-dimensional feature points can correspond to the two-dimensional feature points identified in the controller images (and the one or more map points shown in the one or more headset images).

At step 1510, a pose of the headset is determined based on the set of two-dimensional feature points in each of the one or more headset images and the set of three-dimensional map points. One or more of the two-dimensional feature points can be determined that correspond to one or more of the set of three-dimensional map points. Based on the received three-dimensional map points and the identified corresponding two-dimensional features, the pose of the headset can be determined. A map that includes the set of three-dimensional map points can be stored on the controller and/or the headset. Each map point map can include a map point identifier and a feature identifier associated with each three-dimensional map point of the set of three-dimensional map points.

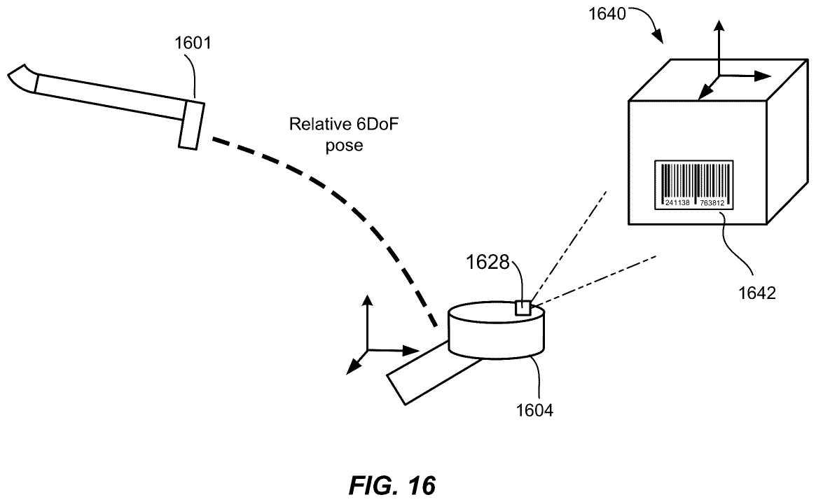

FIG. 16 illustrates an example of localizing an item 1640 with respect to a controller 1604. A headset 1601 can perform controller tracking to determine a 6DOF pose of the controller 1604 with respect to the headset 1601. The controller 1604 can include an active or passive imaging sensor 1628, which may be a controller camera (e.g., controller camera 426 in FIG. 4). The item 1640 may be within a field of view of the imaging sensor 1628. In addition, the item 1640 may not be within a field of view of a headset camera of the headset 1601. So, the headset 1601 may not be able to directly image the item 1640. The imaging sensor 1628 can capture images of the item 1640, or an object 1642 associated with the item 1640 to localize or reconstruct the item 1640 using the headset 1601. To do this, the headset 1601 can receive the images of the item 1640 (or object 1642) from the controller 1604, and based on the pose of the controller 1604 during the imaging of the item 1640, determine the pose of the item 1640 relative to the controller 1604. The headset 1601 can generate virtual content for display at the headset 1601 that is perceived as being at a position of the item 1640. For instance, the virtual content may be a 3D reconstruction of the item 1640.

The controller 1604 or the headset 1601 may additionally read printed codes on the item 1640. For instance, the object 1642 may be a barcode or a quick response (QR) code that identifies the item 1640. The controller 1604 or the headset 1601 can include a reader that is capable of decoding the object 1642 to identify the item 1640. Using the controller 1604 to identify and localize the item 1640 may be useful for efficient traversal and item placement in warehouses, downloading applications based on codes in a store, food scanning for information about an allergy, positioning downloaded objects at certain locations, and handheld 3D scanning for designers.

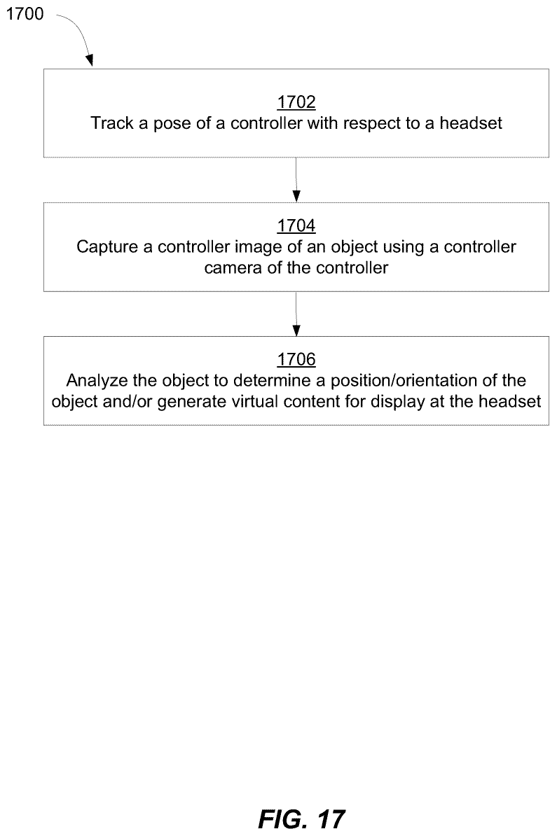

FIG. 17 illustrates an example method 1700 of positioning and virtual reconstruction from scanned objects, according to some embodiments of the present invention. One or more steps of method 1700 may be performed in a different order than the illustrated embodiment, and one or more steps of method 1700 may be omitted during performance of method 1700. Furthermore, two or more steps of method 1700 may be performed simultaneously or concurrently with each other.

At step 1702, a pose of a controller with respect to a headset is tracked. A set of fiducials of the controller may be caused to flash while a headset camera of the headset captures images. The set of fiducials can be identified in the images, and the pose of the controller can be determined based on the identified set of fiducials and a pose of the headset.

At step 1704, a controller image of an object is captured using a controller camera of the controller. The object can be within a field of view of the controller camera, but not in a field of view of the headset camera. Feature points may be identified in the image that correspond to features of the object. For instance, if the item is a box, the feature points may correspond to corners of the box. In addition, the object may include printed code that is depicted in the controller image.

At step 1706, the object is analyzed to determine a position and/or an orientation of the object and/or to generate virtual content for display at the headset. Using the pose of the controller with respect to the headset and the feature points identified in the controller image, the position and/or the orientation of the object relative to the controller may be determined. The headset may then generate virtual content that is perceived as being positioned at the position of the object. For instance, the virtual content may be a three-dimensional reconstruction of the object. Additionally or alternatively, the virtual content may be information (e.g., dimensions, weight, ingredients, materials, etc.) associated with the object. For instance, the printed code may be identified and decoded, which may cause the virtual content to be displayed.

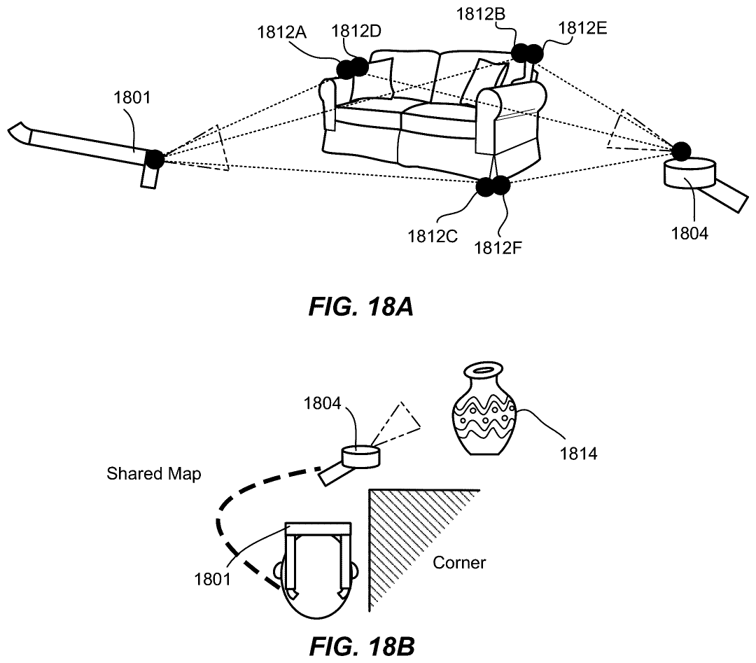

FIGS. 18A-18B illustrate examples of merging map points at a headset or a controller. The headset 1801 and the controller 1804 can each individually generate a map of an environment, as described herein with respect to FIGS. 6-15. The maps can include map points 1812, which correspond to 3D points in the environment representing features. For instance, the headset 1801 can generate a first map based on images captured by a headset camera of the headset 1801. The first map can include map points 1812A-1812C, which correspond to a left arm rest of a couch, a top right corner of the couch, and a bottom right corner of the couch. Similarly, the controller 1804 can generate a second map based on images captured by a controller camera of the controller 1804. The second map can include map points 1812D-1812F, which also correspond to the left arm rest of the couch, the top right corner of the couch, and the bottom right corner of the couch.

The headset 1801 may send the map points 1812A-1812C to the controller 1804 so that the controller 1804 can merge the map points 1812A-1812C with the map points 1812D-1812F. Alternatively, the controller 1804 may send the map points 1812D-1812D to the headset 1801 so that the headset 1801 can merge the map points 1812D-1812F with the map points 1812A-1812C. Merging the map points 1812 may involve combining or averaging the map points. For instance, if map point 1812A and map point 1812D, which both correspond to the left arm rest of the couch, are located at two different positions, the positions may be averaged to generate a new, merged map point for the left arm rest of the couch. If the map point 1812A and map point 1812D are located at the same position, the map points 1812A and 1812D can be combined into a single map point. So, only one of map point 1812A or map point 1812D may be maintained in the map.

In an example, the map points generated by the controller 1804 may not include all of the map points generated by the headset 1801, and vice versa. In this case, merging the map points 1812 may involve adding map points. For instance, the controller 1804 may only generate map points 1812E-1812F based on images captured by the controller camera not showing the left arm rest of the couch (e.g., the left arm rest is not within the field of view of the controller camera when the images are captured). The controller 1804 can receive the map points 1812A-1812C from the headset 1801 and determine that the map point 1812B corresponds to map point 1812E and that map point 1812C corresponds to map point 1812F. The controller 1804 may discard map point 1812B and map point 1812C based on this determination. But, the controller 1804 can determine that map point 1812A does not correspond to a map point generated by the controller 1804, so the controller 1804 can add the map point 1812A to its map. The headset 1801 may perform a similar process for map points generated by the controller 1804 that are not generated by the headset 1801.

So, instead of working independently, the headset 1801 and the controller 1804 can complement each other by sharing a common understanding of the world they see. By sharing the headset map with the controller 1804, the controller 1804 can immediately localize itself onto the same frame of reference of the headset 1801, thus avoiding expensive and often complex initialization issues. In addition, by sharing the headset map with the controller 1804, constellation tracking becomes a redundant source of information. The headset 1801 and the controller 1804 can co-locate each other within the same map and the state of each device can be known with respect to a common reference frame.

In FIG. 18B, the map of the controller 1804 is shared with the headset 1801 so that the headset 1801 can visualize a map area before seeing the map area itself. The controller 1804 can generate map points for an object 1814 that is not within a field of view of the headset camera of the headset 1801. For instance, the object 1814 may be around a corner from the headset 1801. In addition, the headset 1801 may not have previously generated a map point for the object 1814. Once the controller 1804 captures images of the object 1814 and generates map points for the object 1814, the controller can send the map that includes the map points to the headset 1801, which can then display virtual content relating to the object 1814, even though the headset 1801 has not explored the area that includes the object 1814. The resulting map from combining both inside-out tracking systems may be a higher quality than individual maps, given that more views of the same space induces stronger constraints on individual map points and potential baselines are significantly higher.

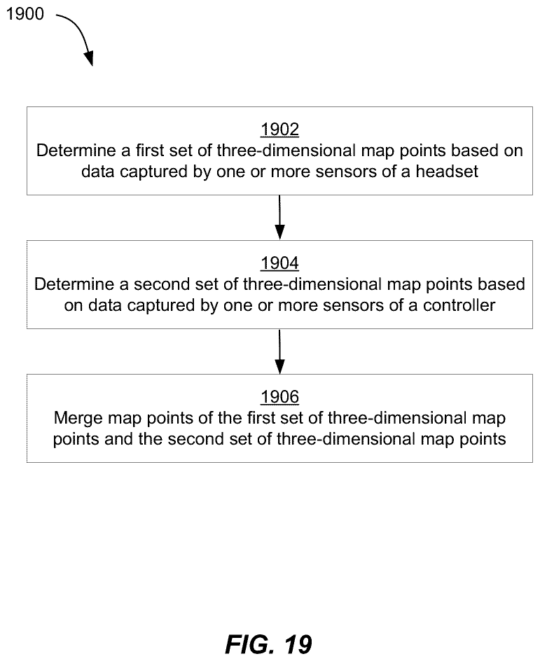

FIG. 19 illustrates an example method 1900 of merging map points at a headset or a controller, according to some embodiments of the present invention. One or more steps of method 1900 may be performed in a different order than the illustrated embodiment, and one or more steps of method 1900 may be omitted during performance of method 1900. Furthermore, two or more steps of method 1900 may be performed simultaneously or concurrently with each other.

At step 1902, a first set of three-dimensional map points is determined based on data captured by one or more sensors of a headset. The sensors may include a left front-facing world camera, a right front-facing world camera, a left side-facing world camera, a right side-facing world camera, a depth sensor, and/or an IMU. The data may include headset images generated by a headset camera of the headset. Two-dimensional feature points can be identified in the headset images, and three-dimensional map points corresponding to the two-dimensional feature points can be generated.

At step 1904, a second set of three-dimensional map points is determined based on data captured by one or more sensors of a controller. The sensors may include a front controller camera, a rear controller camera, and/or an IMU. The data may include controller images generated by a controller camera of the controller. Two-dimensional feature points can be identified in the controller images, and three-dimensional map points corresponding to the two-dimensional feature points can be generated.

At step 1906, map points of the first set of three-dimensional map points and the second set of three-dimensional map points are merged. To merge the map points, the first set of three-dimensional map points may be sent from the headset to the controller to merge one or more of the first set of three-dimensional map points with the second set of three-dimensional map points. Additionally or alternatively, the second set of three-dimensional map points may be sent from the controller to the headset to merge one or more of the second set of three-dimensional map points with the first set of three-dimensional map points. Merging the map points may involve adding map points, combining map points, and/or averaging map points.

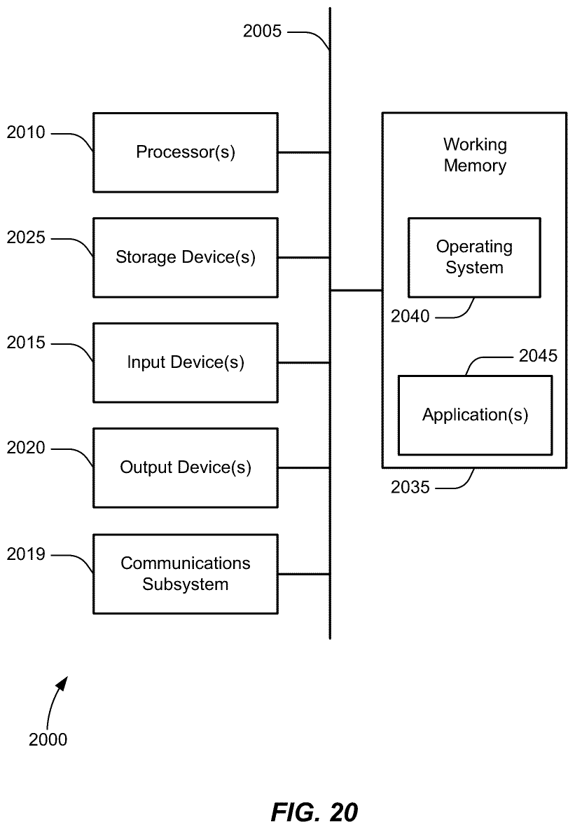

FIG. 20 illustrates a simplified computer system 2000 according to an embodiment described herein. Computer system 2000 as illustrated in FIG. 20 may be incorporated into devices described herein. FIG. 20 provides a schematic illustration of one embodiment of computer system 2000 that can perform some or all of the steps of the methods provided by various embodiments. It should be noted that FIG. 20 is meant only to provide a generalized illustration of various components, any or all of which may be utilized as appropriate. FIG. 20, therefore, broadly illustrates how individual system elements may be implemented in a relatively separated or relatively more integrated manner.

Computer system 2000 is shown comprising hardware elements that can be electrically coupled via a bus 2005, or may otherwise be in communication, as appropriate. The hardware elements may include one or more processors 2010, including without limitation one or more general-purpose processors and/or one or more special-purpose processors such as digital signal processing chips, graphics acceleration processors, and/or the like; one or more input devices 2015, which can include without limitation a mouse, a keyboard, a camera, and/or the like; and one or more output devices 2020, which can include without limitation a display device, a printer, and/or the like.

Computer system 2000 may further include and/or be in communication with one or more non-transitory storage devices 2025, which can comprise, without limitation, local and/or network accessible storage, and/or can include, without limitation, a disk drive, a drive array, an optical storage device, a solid-state storage device, such as a random access memory (“RAM”), and/or a read-only memory (“ROM”), which can be programmable, flash-updateable, and/or the like. Such storage devices may be configured to implement any appropriate data stores, including without limitation, various file systems, database structures, and/or the like.

Computer system 2000 might also include a communications subsystem 2019, which can include without limitation a modem, a network card (wireless or wired), an infrared communication device, a wireless communication device, and/or a chipset such as a Bluetooth™ device, an 802.11 device, a WiFi device, a WiMax device, cellular communication facilities, etc., and/or the like. The communications subsystem 2019 may include one or more input and/or output communication interfaces to permit data to be exchanged with a network such as the network described below to name one example, other computer systems, television, and/or any other devices described herein. Depending on the desired functionality and/or other implementation concerns, a portable electronic device or similar device may communicate image and/or other information via the communications subsystem 2019. In other embodiments, a portable electronic device, e.g., the first electronic device, may be incorporated into computer system 2000, e.g., an electronic device as an input device 2015. In some embodiments, computer system 2000 will further comprise a working memory 2035, which can include a RAM or ROM device, as described above.

Computer system 2000 also can include software elements, shown as being currently located within the working memory 2035, including an operating system 2040, device drivers, executable libraries, and/or other code, such as one or more application programs 2045, which may comprise computer programs provided by various embodiments, and/or may be designed to implement methods, and/or configure systems, provided by other embodiments, as described herein. Merely by way of example, one or more procedures described with respect to the methods discussed above, might be implemented as code and/or instructions executable by a computer and/or a processor within a computer; in an aspect, then, such code and/or instructions can be used to configure and/or adapt a general purpose computer or other device to perform one or more operations in accordance with the described methods.

A set of these instructions and/or code may be stored on a non-transitory computer-readable storage medium, such as the storage device(s) 2025 described above. In some cases, the storage medium might be incorporated within a computer system, such as computer system 2000. In other embodiments, the storage medium might be separate from a computer system e.g., a removable medium, such as a compact disc, and/or provided in an installation package, such that the storage medium can be used to program, configure, and/or adapt a general purpose computer with the instructions/code stored thereon. These instructions might take the form of executable code, which is executable by computer system 2000 and/or might take the form of source and/or installable code, which, upon compilation and/or installation on computer system 2000 e.g., using any of a variety of generally available compilers, installation programs, compression/decompression utilities, etc., then takes the form of executable code.

It will be apparent to those skilled in the art that substantial variations may be made in accordance with specific requirements. For example, customized hardware might also be used, and/or particular elements might be implemented in hardware, software including portable software, such as applets, etc., or both. Further, connection to other computing devices such as network input/output devices may be employed.

As mentioned above, in one aspect, some embodiments may employ a computer system such as computer system 2000 to perform methods in accordance with various embodiments of the technology. According to a set of embodiments, some or all of the procedures of such methods are performed by computer system 2000 in response to processor 2010 executing one or more sequences of one or more instructions, which might be incorporated into the operating system 2040 and/or other code, such as an application program 2045, contained in the working memory 2035. Such instructions may be read into the working memory 2035 from another computer-readable medium, such as one or more of the storage device(s) 2025. Merely by way of example, execution of the sequences of instructions contained in the working memory 2035 might cause the processor(s) 2010 to perform one or more procedures of the methods described herein. Additionally or alternatively, portions of the methods described herein may be executed through specialized hardware.

The terms “machine-readable medium” and “computer-readable medium,” as used herein, refer to any medium that participates in providing data that causes a machine to operate in a specific fashion. In an embodiment implemented using computer system 2000, various computer-readable media might be involved in providing instructions/code to processor(s) 2010 for execution and/or might be used to store and/or carry such instructions/code. In many implementations, a computer-readable medium is a physical and/or tangible storage medium. Such a medium may take the form of a non-volatile media or volatile media. Non-volatile media include, for example, optical and/or magnetic disks, such as the storage device(s) 2025. Volatile media include, without limitation, dynamic memory, such as the working memory 2035.

Common forms of physical and/or tangible computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, EPROM, a FLASH-EPROM, any other memory chip or cartridge, or any other medium from which a computer can read instructions and/or code.

Various forms of computer-readable media may be involved in carrying one or more sequences of one or more instructions to the processor(s) 2010 for execution. Merely by way of example, the instructions may initially be carried on a magnetic disk and/or optical disc of a remote computer. A remote computer might load the instructions into its dynamic memory and send the instructions as signals over a transmission medium to be received and/or executed by computer system 2000.

The communications subsystem 2019 and/or components thereof generally will receive signals, and the bus 2005 then might carry the signals and/or the data, instructions, etc. carried by the signals to the working memory 2035, from which the processor(s) 2010 retrieves and executes the instructions. The instructions received by the working memory 2035 may optionally be stored on a non-transitory storage device 2025 either before or after execution by the processor(s) 2010.

The methods, systems, and devices discussed above are examples. Various configurations may omit, substitute, or add various procedures or components as appropriate. For instance, in alternative configurations, the methods may be performed in an order different from that described, and/or various stages may be added, omitted, and/or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

Specific details are given in the description to provide a thorough understanding of exemplary configurations including implementations. However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations will provide those skilled in the art with an enabling description for implementing described techniques. Various changes may be made in the function and arrangement of elements without departing from the spirit or scope of the disclosure.

Also, configurations may be described as a process which is depicted as a schematic flowchart or block diagram. Although each may describe the operations as a sequential process, many of the operations can be performed in parallel or concurrently. In addition, the order of the operations may be rearranged. A process may have additional steps not included in the figure. Furthermore, examples of the methods may be implemented by hardware, software, firmware, middleware, microcode, hardware description languages, or any combination thereof. When implemented in software, firmware, middleware, or microcode, the program code or code segments to perform the necessary tasks may be stored in a non-transitory computer-readable medium such as a storage medium. Processors may perform the described tasks.

Having described several example configurations, various modifications, alternative constructions, and equivalents may be used without departing from the spirit of the disclosure. For example, the above elements may be components of a larger system, wherein other rules may take precedence over or otherwise modify the application of the technology. Also, a number of steps may be undertaken before, during, or after the above elements are considered. Accordingly, the above description does not bind the scope of the claims.

As used herein and in the appended claims, the singular forms “a”, “an”, and “the” include plural references unless the context clearly dictates otherwise. Thus, for example, reference to “a user” includes a plurality of such users, and reference to “the processor” includes reference to one or more processors and equivalents thereof known to those skilled in the art, and so forth.

Also, the words “comprise”, “comprising”, “contains”, “containing”, “include”, “including”, and “includes”, when used in this specification and in the following claims, are intended to specify the presence of stated features, integers, components, or steps, but they do not preclude the presence or addition of one or more other features, integers, components, steps, acts, or groups.

It is also understood that the examples and embodiments described herein are for illustrative purposes only and that various modifications or changes in light thereof will be suggested to persons skilled in the art and are to be included within the spirit and purview of this application and scope of the appended claims.

What is claimed is:

1. A method of operating a wearable system comprising a headset and a controller, the method comprising:
causing a set of fiducials of the controller to flash, the set of fiducials being arranged in a known geometry;
tracking a pose of the controller by:
capturing a set of headset images using a headset camera of the headset;
identifying the set of fiducials in the set of headset images; and
tracking the pose of the controller based on the identified set of fiducials in the set of headset images and based on a pose of the headset;
while tracking the pose of the controller, capturing a set of controller images using a controller camera of the controller;
identifying a set of two-dimensional feature points in each controller image of the set of controller images; and
determining a set of three-dimensional map points based on the set of two-dimensional feature points and the pose of the controller.

2. The method of claim 1, wherein the wearable system comprises:
the headset comprising:
the headset camera; and
a headset inertial measurement unit; and
the controller comprising:
the set of fiducials arranged in the known geometry;
the controller camera; and
a controller inertial measurement unit;
wherein the wearable system is configured to determine a position or orientation of the headset or the controller based on data captured by the headset camera, the controller camera, the headset inertial measurement unit, or the controller inertial measurement unit.

3. The method of claim 1, further comprising:
generating a map using the set of three-dimensional map points, wherein each three-dimensional map point of the set of three-dimensional map points corresponds to a particular feature in an environment of the wearable system.

4. The method of claim 3, wherein the map comprises a map point identifier and a feature identifier associated with each three-dimensional map point of the set of three-dimensional map points.

5. The method of claim 3, wherein the map comprises a list of keyframe poses and a corresponding list of the set of two-dimensional feature points for each three-dimensional map point of the set of three-dimensional map points.

6. The method of claim 1, further comprising:
generating a set of transforms representing a position and an orientation of the controller relative to the headset at a set of time instances corresponding to when each of the set of controller images were captured; and
associating the set of transforms with the set of controller images.

7. The method of claim 6, further comprising:
determining a location of a three-dimensional map point of the set of three-dimensional map points by triangulating a two-dimensional feature point of the set of two-dimensional feature points in each of the set of controller images using the set of transforms.

8. A wearable system comprising:
a headset;
a controller having a set of fiducials; and
one or more processors configured to perform operations comprising:
causing the set of fiducials of the controller to flash, the set of fiducials 5 being arranged in a known geometry;
tracking a pose of the controller by:
capturing a set of headset images using a headset camera of the headset;
identifying the set of fiducials in the set of headset images; and
tracking the pose of the controller based on the identified set of fiducials in the set of headset images and based on a pose of the headset;
while tracking the pose of the controller, capturing a set of controller images using a controller camera of the controller;
identifying a set of two-dimensional feature points in each controller image of the set of controller images; and
determining a set of three-dimensional map points based on the set of two-dimensional feature points and the pose of the controller.

9. The wearable system of claim 8, wherein:
the headset comprises:
the headset camera; and
a headset inertial measurement unit; and
the controller comprises:
the set of fiducials arranged in the known geometry;
the controller camera; and
a controller inertial measurement unit; and
the wearable system is configured to determine a position or orientation of the headset or the controller based on data captured by the headset camera, the controller camera, the headset inertial measurement unit, or the controller inertial measurement unit.

10. The wearable system of claim 8, wherein the operations further comprise:
generating a map using the set of three-dimensional map points, wherein each three-dimensional map point of the set of three-dimensional map points corresponds to a particular feature in an environment of the wearable system.

11. The wearable system of claim 10, wherein the map comprises a map point identifier and a feature identifier associated with each three-dimensional map point of the set of three-dimensional map points.

12. The wearable system of claim 10, wherein the map comprises a list of keyframe poses and a corresponding list of the set of two-dimensional feature points for each three-dimensional map point of the set of three-dimensional map points.

13. The wearable system of claim 8, wherein the operations further comprise:
generating a set of transforms representing a position and an orientation of the controller relative to the headset at a set of time instances corresponding to when each of the set of controller images were captured; and
associating the set of transforms with the set of controller images.

14. The wearable system of claim 13, wherein the operations further comprise:
determining a location of a three-dimensional map point of the set of three-dimensional map points by triangulating a two-dimensional feature point of the set of two-dimensional feature points in each of the set of controller images using the set of transforms.

15. A non-transitory computer-readable medium comprising instructions that, when executed by one or more processors, cause the one or more processors to perform operations for operating a wearable system comprising a headset and a controller, the operations comprising:
causing a set of fiducials of the controller to flash, the set of fiducials being arranged in a known geometry;
tracking a pose of the controller by:
capturing a set of headset images using a headset camera of the headset;
identifying the set of fiducials in the set of headset images; and
tracking the pose of the controller based on the identified set of fiducials in the set of headset images and based on a pose of the headset;
while tracking the pose of the controller, capturing a set of controller images using a controller camera of the controller;
identifying a set of two-dimensional feature points in each controller image of the set of controller images; and
determining a set of three-dimensional map points based on the set of two-dimensional feature points and the pose of the controller.

16. The non-transitory computer-readable medium of claim 15, wherein the wearable system comprises:
the headset comprising:
the headset camera; and
a headset inertial measurement unit; and
the controller comprising:
the set of fiducials arranged in the known geometry;
the controller camera; and
a controller inertial measurement unit;
wherein the wearable system is configured to determine a position or orientation of the headset or the controller based on data captured by the headset camera, the controller camera, the headset inertial measurement unit, or the controller inertial measurement unit.

17. The non-transitory computer-readable medium of claim 15, wherein the operations further comprise:
generating a map using the set of three-dimensional map points, wherein each three-dimensional map point of the set of three-dimensional map points corresponds to a particular feature in an environment of the wearable system.

18. The non-transitory computer-readable medium of claim 17, wherein the map comprises a map point identifier and a feature identifier associated with each three-dimensional map point of the set of three-dimensional map points.

19. The non-transitory computer-readable medium of claim 17, wherein the map comprises a list of keyframe poses and a corresponding list of the set of two-dimensional feature points for each three-dimensional map point of the set of three-dimensional map points.

20. The non-transitory computer-readable medium of claim 15, wherein the operations further comprise:
generating a set of transforms representing a position and an orientation of the controller relative to the headset at a set of time instances corresponding to when each of the set of controller images were captured; and
associating the set of transforms with the set of controller images.
